(19) United States
(12) Patent Application Publication
(10) Pub. No.: US 2022/0112996 A1
(43) Pub. Date: Apr. 14, 2022

(54) JEWELRY AND GEM STONE LIGHTING SYSTEMS AND APPARATUSES AND METHOD MAKING AND USING SAME

(71) Applicants: Paul Ashley, Brazoria, TX (US); Brooke Ashley, Brazoria, TX (US)

(72) Inventors: Paul Ashley, Brazoria, TX (US); Brooke Ashley, Brazoria, TX (US)

(21) Appl. No.: 17/477,773

(22) Filed: Sep. 17, 2021

Related U.S. Application Data
(60) Provisional application No. 63/080,221, filed on Sep. 18, 2020.

(51) Int. Cl. F21S 9/04; A44C 15/00; F21V 33/00; H02J 50/00; H02J 50/20; H02J 50/10

(52) U.S. Cl. CPC F21S 9/04; A44C 15/0015; H02J 50/10; H02J 50/001; H02J 50/20; F21V 33/0008

(57) ABSTRACT

Jewelry and gem stone lighting apparatuses and systems including light emitting elements powered either by body heat or via external fields and methods for making and using same.

### RELATED APPLICATIONS

This application claims the benefit of and priority to U.S. Provisional Patent Application Ser. No. 63/080,221 filed Sep. 18, 2020 (18 Sep. 2020).

### BACKGROUND OF THE DISCLOSURE

### 1. Field of the Disclosure

Embodiments of the present disclosure relate to jewelry and gem stone lighting systems and methods for making and using same.

In particular, embodiments of the present disclosure relate to jewelry and gem stone lighting systems, wherein the lighting systems include one or more power generating elements and one or more light emitting elements and methods for making and using same. In certain embodiments, the power generating elements utilize body heat to generate electric power. In other embodiments, the power generating elements are coils designed to be energized by external electromagnetic fields. The power generating elements are designed to be in thermal contact with a body part of an animal, a mammal, or a human.

### 2. Description of the Related Art

While there are several methods for lighting jewelry and gem stones, most of these methods involve battery powered units powering light emitting elements such as LEDs or LCDs. Thus, there is still a need in the art for light weight systems and methods for illuminating jewelry and gem stones, where the powered is derived from the wearer or from external electromagnetic fields.

### SUMMARY OF THE DISCLOSURE

Embodiments of this disclosure provide apparatuses and systems including one or more thermal power generating elements or body heat power generating elements and one or more light emitting elements. In certain embodiments, the elements produce electrical energy when brought in contact with a body part of an animal, a mammal, or a human. In other embodiments, the elements produce electrical energy from via an antenna designed to receive energy from a portable electric field generator. The apparatuses and systems also include a hydrogel or other hypoallergenic polymeric materials encasing the power generating elements and optionally the light emitting elements. In certain embodiments, the power generating elements are embedded or surrounded/encased in the hydrogel or hypoallergenic polymeric material. In other embodiments, the power generating elements utilize either heat energy derived from the body of a wearer (an animal, a mammal, or a human) or from electricity derived from neurons or from brain waves. The energy is then used to power the light emitting elements. In other embodiments, the power generating elements comprise a plurality of multi-layered power generating constructs including conductor layers, insulator layers, and p/n semiconductor layers that convert body heat into electrical energy. The power generating elements also comprise two power leads for connecting the power generating elements to one other and to one or more light emitting elements. In other embodiments, the power generating elements may be coils designed to be energized by a cell phone, cell signals or other electromagnetic fields.

Embodiments of this disclosure also provide methods for making jewelry including one or more power generating elements and one or more light emitting elements, where the methods include constructing the power generating elements, affixing the power generating elements to a piece of jewelry, and connecting the leads of the generating elements to the light emitting elements disposed on the jewelry to illuminate one or more gem stones associated with the jewelry.

Embodiments of this disclosure also provide methods for using the apparatuses and systems of this disclosure, wherein the methods including wearing a piece of jewelry including an apparatus of this disclosure so that the power generating elements are in thermal contact with the skin of the wearer providing power to one or more light emitting elements to illuminate one or more gem stones associated with the jewelry.

Embodiments of this disclosure also provide apparatuses, systems, and methods implementing them, where the apparatuses and systems include a jewelry article including an lighting apparatus of this disclosure. The lighting apparatuses include one or more power generating members, one or more light emitting members, one or more processing units, and one or more sensors, wherein the power generating members supplies or is configured to supply power to the other components, the processing unit controls or is configured to receive information from the sensors and to control the light emitting members based on the information received from the sensors and varying the light output from the light emitting members over time according to pre-programmed routines, randomly varying the output based on sensor input data, or by any other software routine for varying the output over time based on sensor input data. The sensors include, without limitation, thermal sensors, light sensors, sound sensors, motion sensors, other sensors, or any combination thereof, where each sensor type is any sensor known in the art or yet to be invented that is capable of detecting the properties sought.

Embodiments of this disclosure also provide apparatuses, systems, and methods implementing them, where the apparatuses and systems include a jewelry article including an lighting apparatus of this disclosure. The lighting apparatuses include one or more power generating members, one or more light emitting members, one or more processing units, and one or more sensors, wherein the power generating members supplies or is configured to supply power to the other components, the processing unit controls or is configured to receive information from the sensors and to control the light emitting members based on the information received from the sensors and varying the light output from the light emitting members over time according to pre-programmed routines, randomly varying the output based on sensor input data, or by any other software routine for varying the output over time based on sensor input data. The sensors include, without limitation, thermal sensors, light sensors, sound sensors, motion sensors, other sensors, or any combination thereof, where each sensor type is any sensor known in the art or yet to be invented that is capable of detecting the properties sought. The one or more power generating members comprising a portable electric field generator and an antenna disposed in the jewelry article, which absorbs energy from the electric field produced by the portable electric field generators to provide power to the other components of the lighting apparatus associated with the jewelry article.

### BRIEF DESCRIPTION OF THE DRAWINGS OF THE DISCLOSURE

The disclosure may b le better understood with reference to the following detailed description together with the appended illustrative drawings in which like elements are numbered the same:

FIGS. 1A-C depicts an embodiment of a ring of this disclosure including a power generating member and a light emitting member.

FIGS. 2A-C depicts another embodiment of a ring of this disclosure including a power generating member and a light emitting member.

FIGS. 3A-C depicts another embodiment of a ring of this disclosure including a power generating member and a light emitting member.

FIGS. 4A-C depicts an embodiment of a power generating member of this disclosure comprising p and n semiconductor elements.

FIGS. 5A-C depicts another embodiment of a power generating member of this disclosure comprising antennas.

FIGS. 6A-C depicts an embodiment of an earring of this disclosure including a power generating member comprising p and n semiconductor elements and a light emitting member.

FIG. 7 depicts another embodiment of an earring of this disclosure including a power generating member comprising p and n semiconductor elements and a light emitting member.

FIG. 8 depicts another embodiment of an earring of this disclosure including a power generating member comprising p and n semiconductor elements and a light emitting member.

FIG. 9 depicts another embodiment of an earring of this disclosure including a power generating member comprising p and n semiconductor elements and a light emitting member.

FIGS. 10A&B depicts an embodiment of jewelry illuminating adhesive constructs of this disclosure including a power generating member comprising p and n semiconductor elements and a light emitting member.

FIGS. 11A&B depicts another embodiment of jewelry illuminating adhesive constructs of this disclosure including a power generating member comprising antennas and a light emitting member.

FIGS. 12A-C depicts three different single color light emitting members, wherein the colors are red (R), green (G), and blue (B).

FIGS. 13A-C depicts three 3×3 light emitting members including different patterns of red (R), green (G), and blue (B) elements.

FIGS. 14A-C depicts three 9×9 light emitting members including different patterns of red (R), green (G), and blue (B) elements.

FIGS. 15A-C depicts three apparatuses of this invention including two power supply member, a processor or processing unit, a light emitting member and various sensors, here a thermal sensor, a light sensor, and a sound sensor.

### DEFINITIONS USED IN THE DISCLOSURE

The term “at least one” means one or more or one or a plurality, additionally, these three terms may be used interchangeably within this application. For example, at least one device means one or more devices or one device and a plurality of devices.

The term “one or a plurality” means one item or a plurality of items.

The term “about” means that a value of a given quantity is within ±20% of the stated value. In other embodiments, the value is within ±15% of the stated value. In other embodiments, the value is within ±10% of the stated value. In other embodiments, the value is within ±5% of the stated value. In other embodiments, the value is within ±2.5% of the stated value. In other embodiments, the value is within ±1% of the stated value.

The term “substantially” means that a value of a given quantity is within ±5% of the stated value. In other embodiments, the value is within ±2.5% of the stated value. In other embodiments, the value is within ±2% of the stated value. In other embodiments, the value is within ±1% of the stated value. In other embodiments, the value is within ±0.1% of the stated value.

The term “N-type semiconductor” or “n-type semiconductor” means a construct created by adding pentavalent impurities like phosphorus (P), arsenic (As), antimony (Sb), or bismuth (Bi) to a semiconductor such as silicon (Si), germanium (Ge), gallium arsenide (GaAs), indium phosphide (InP). A pentavalent impurity is called a donor atom because it is ready to give a free electron to a semiconductor. The impurities are called dopants.

The term “P-type semiconductor” or “p-type semiconductor” means is a type of semiconductor construct created by adding trivalent impurities like boron (B), aluminum (Al), or gallium (Ga) to a semiconductor such as silicon (Si), germanium (Ge), gallium arsenide (GaAs), indium phosphide (InP). A p-type semiconductor has more holes than electrons. This allows the current to flow along the material from hole to hole, but only in one direction.

### DETAILED DESCRIPTION OF THE DISCLOSURE

The inventors have found that jewelry may be constructed with one or more light emitting elements to illuminate gem stones associated with the jewelry using either energy derived from the body such as power generating elements that utilize body heat or power generating elements energized by electromagnetic fields generated by a cell phone or other electronic devices. The jewelry may be rings, watches, earrings, necklaces, pendants, bracelets, ankle bracelets, chokers, or any other jewelry including gem stones.

Embodiments of this disclosure broadly related to apparatuses and systems including one or more thermal power generating elements or body heat power generating elements and one or more light emitting elements. In certain embodiments, the elements produce electrical energy when brought in contact with a body part of an animal, a mammal, or a human. In other embodiments, the elements produce electrical energy from via an antenna designed to receive energy from a portable electric field generator. The apparatuses and systems also include a hydrogel or other hypoallergenic polymeric materials encasing the power generating elements and optionally the light emitting elements. In certain embodiments, the power generating elements are embedded or surrounded/encased in the hydrogel or hypoallergenic polymeric material. In other embodiments, the power generating elements utilize either heat energy derived from the body of a wearer (an animal, a mammal, or a human) or from electricity derived from neurons or from brain waves. The energy is then used to power the light emitting elements. In other embodiments, the power generating elements comprise a plurality of multi-layered power generating constructs including conductor layers, insulator layers, and p/n semiconductor layers that convert body heat into electrical energy. The power generating elements also comprise two power leads for connecting the power generating elements to one other and to one or more light emitting elements. In other embodiments, the power generating elements may be coils designed to be energized by a cell phone, cell signals or other electromagnetic fields.

Embodiments of this disclosure also broadly related to methods for making jewelry including one or more power generating elements and one or more light emitting elements, where the methods include constructing the power generating elements, affixing the power generating elements to a piece of jewelry, and connecting the leads of the generating elements to the light emitting elements disposed on the jewelry to illuminate one or more gem stones associated with the jewelry.

Embodiments of this disclosure also provide methods for using the apparatuses and systems of this disclosure, wherein the methods including wearing a piece of jewelry including an apparatus of this disclosure so that the power generating elements are in thermal contact with the skin of the wearer providing power to one or more light emitting elements to illuminate one or more gem stones associated with the jewelry.

Embodiments of this disclosure also broadly related to apparatuses, systems, and methods implementing them, where the apparatuses and systems include a jewelry article including an lighting apparatus of this disclosure. The lighting apparatuses include one or more power generating members, one or more light emitting members, one or more processing units, and one or more sensors, wherein the power generating members supplies or is configured to supply power to the other components, the processing unit controls or is configured to receive information from the sensors and to control the light emitting members based on the information received from the sensors and varying the light output from the light emitting members over time according to pre-programmed routines, randomly varying the output based on sensor input data, or by any other software routine for varying the output over time based on sensor input data. The sensors include, without limitation, thermal sensors, light sensors, sound sensors, motion sensors, other sensors, or any combination thereof, where each sensor type is any sensor known in the art or yet to be invented that is capable of detecting the properties sought.

Embodiments of this disclosure also broadly related to apparatuses, systems, and methods implementing them, where the apparatuses and systems include a jewelry article including an lighting apparatus of this disclosure. The lighting apparatuses include one or more power generating members, one or more light emitting members, one or more processing units, and one or more sensors, wherein the power generating members supplies or is configured to supply power to the other components, the processing unit controls or is configured to receive information from the sensors and to control the light emitting members based on the information received from the sensors and varying the light output from the light emitting members over time according to pre-programmed routines, randomly varying the output based on sensor input data, or by any other software routine for varying the output over time based on sensor input data. The sensors include, without limitation, thermal sensors, light sensors, sound sensors, motion sensors, other sensors, or any combination thereof, where each sensor type is any sensor known in the art or yet to be invented that is capable of detecting the properties sought. The one or more power generating members comprising a portable electric field generator and an antenna disposed in the jewelry article, which absorbs energy from the electric field produced by the portable electric field generators to provide power to the other components of the lighting apparatus associated with the jewelry article.

Light emitting elements for use in this disclosure comprise flexible or rigid multilayer constructs including inorganic light emitting diodes (LEDs), organic light emitting diodes (OLEDs), polymeric light-emitting diodes (PLEDs), ultraflexible LEDs, ultraflexible PLEDs, ultraflexible OLEDs, ultrathin LEDs, ultrathin PLEDs, ultrathin OLEDs, ultrathin and ultraflexible LEDs, ultrathin and ultraflexible PLEDs, ultrathin and ultraflexible OLEDs, and any mixture or combination of these light emitting elements. Such light emitting diodes for use in this disclosure including diodes manufactured by Sumitomo Chemicals, the Merck Group, Samsung, LG, Sony, Apple, Nokia, Panasonic, and any other manufacturer of LEDs, OLEDs, and PLEDs.

The power generating elements may be p-type and n-type semiconductor constructs that are designed to generate electricity based on thermal energy generated by the body. These constructs, when placed in contact with the skin of a wearer, generate electricity sufficient to power the light emitting elements that may be used to illuminated gem stones associated with pieces of jewelry. In another construction, power is extracted from external fields using receiving coils in the jewelry to power the light emitting elements that may be used to illuminated gem stones associated with pieces of jewelry. In certain embodiments, the power generating elements may be a combination of thermal electric generators (body heat generators) and external field powered coil receivers.

### DETAILED DESCRIPTION OF THE DRAWINGS OF THE DISCLOSURE

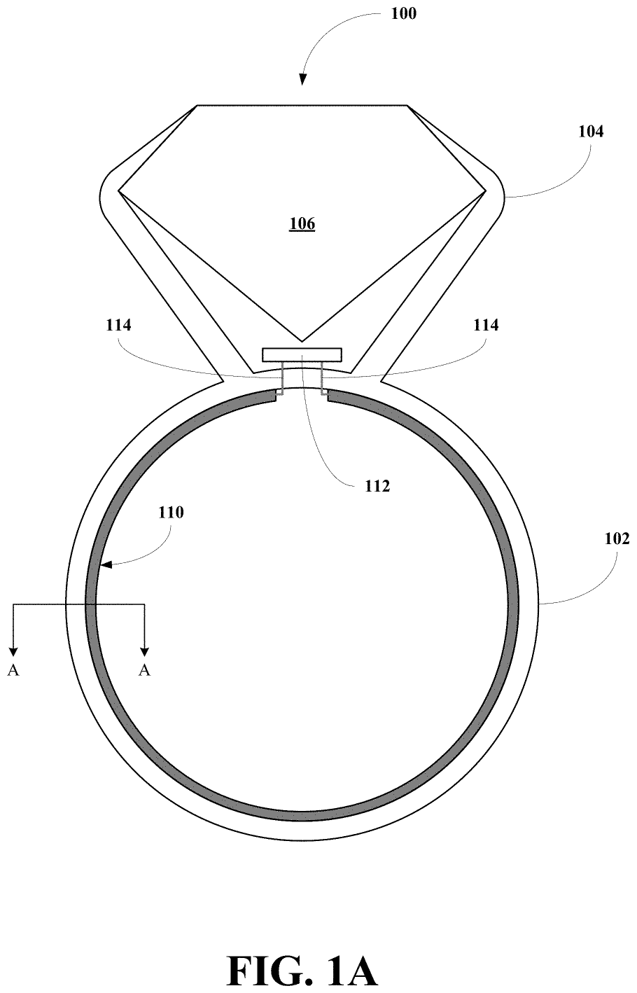

Referring now to FIGS. 1A-C, a cross-sectional view, a view looking down below the gem stone, and a view along a cutting line A-A of an embodiment of a ring of this disclosure, generally 100, is shown to include a finger portion 102 and gem stone prongs 104 holding a gem stone 106 and an aperture 108. The ring 100 also includes a power generating member 110 and a light emitting member 112, wherein the power generating member 110 is in electrical communication with the light emitting member 112 via electric wires 114. Looking at FIG. 1B, the power generating member 110 also includes a plus contact 116 and a negative contact 118 and the aperture 108 has an aperture mount 120.

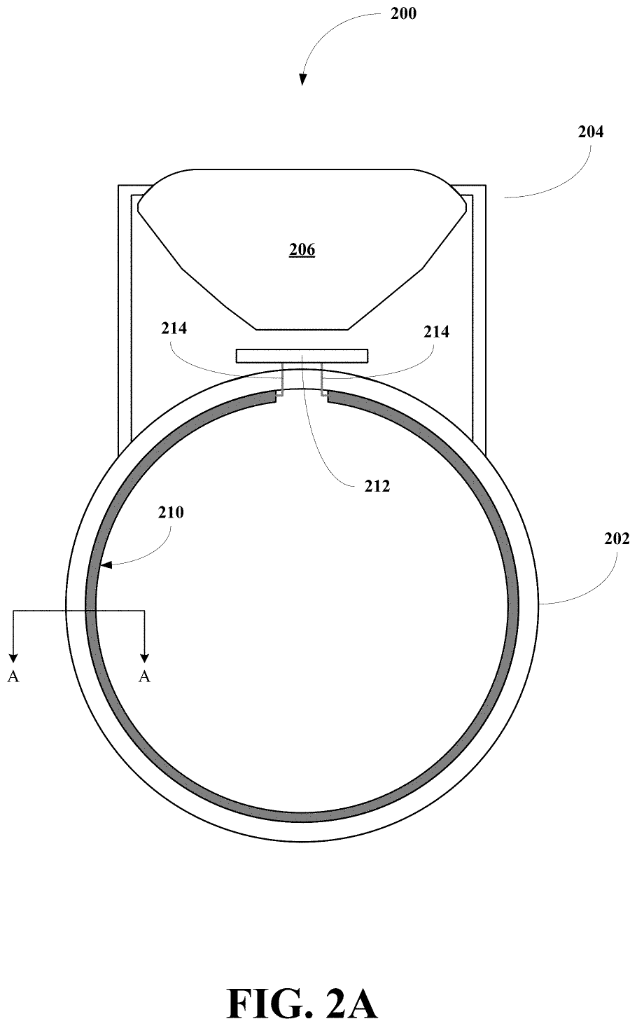

Referring now to FIGS. 2A-C, a cross-sectional view, a view looking down below the gem stone, and a view along a cutting line A-A of another embodiment of a ring of this disclosure, generally 200, is shown to include a finger portion 202 and gem stone prongs 204 holding a gem stone 206 and an aperture 208. The ring 200 also includes a power generating member 210 and a light emitting member 212, wherein the power generating member 210 is in electrical communication with the light emitting member 212 via electric wires 214. Looking at FIG. 2B, the power generating member 210 also includes a plus contact 216 and a negative contact 218 and the aperture 208 has an aperture mount 220.

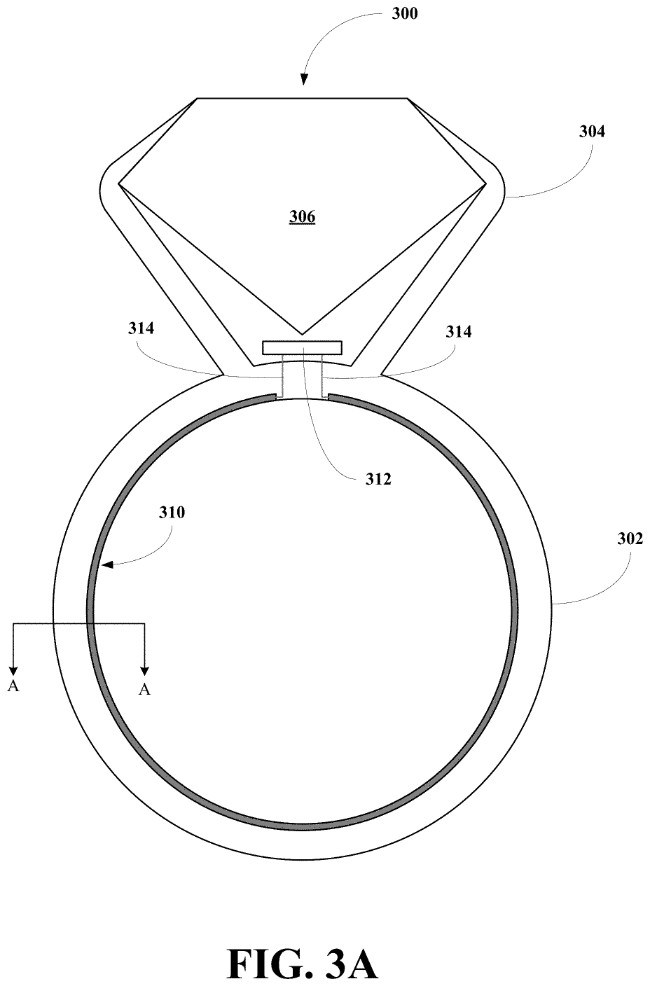

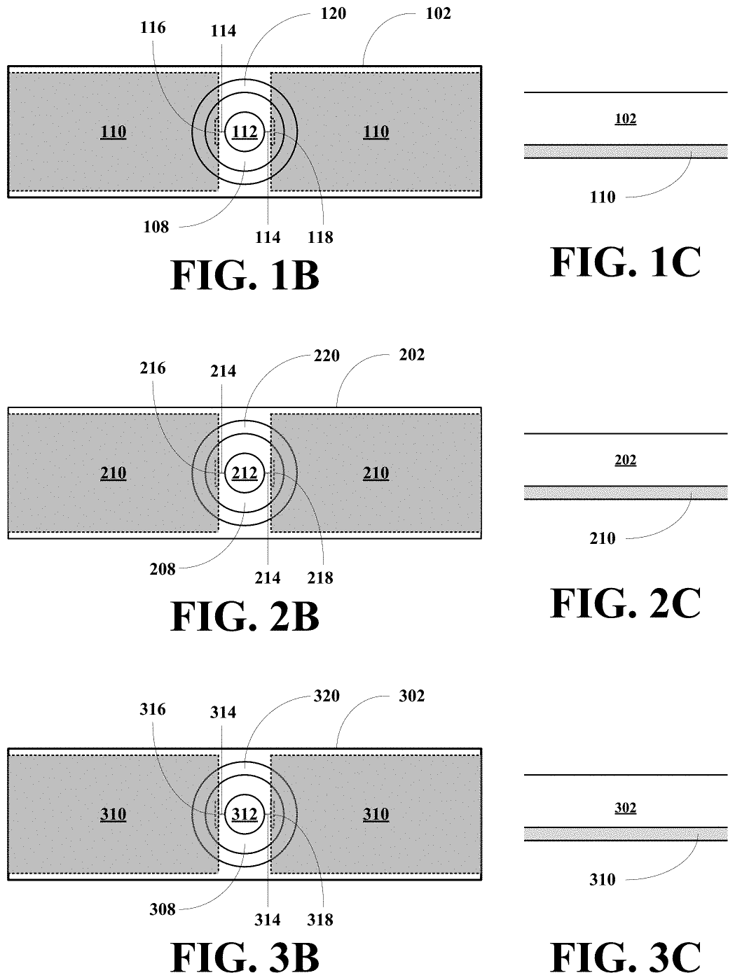

Referring now to FIGS. 3A-C, a cross-sectional view, a view looking down below the gem stone, and a view along a cutting line A-A of another embodiment of a ring of this disclosure, generally 300, is shown to include a finger portion 302 and gem stone prongs 304 holding a gem stone 306 and an aperture 308. The ring 300 also includes a power generating member 310 and a light emitting member 312, wherein the power generating member 310 is in electrical communication with the light emitting member 312 via electric wires 314. Looking at FIG. 3B, the power generating member 310 also includes a plus contact 316 and a negative contact 318 and the aperture 308 has an aperture mount 320.

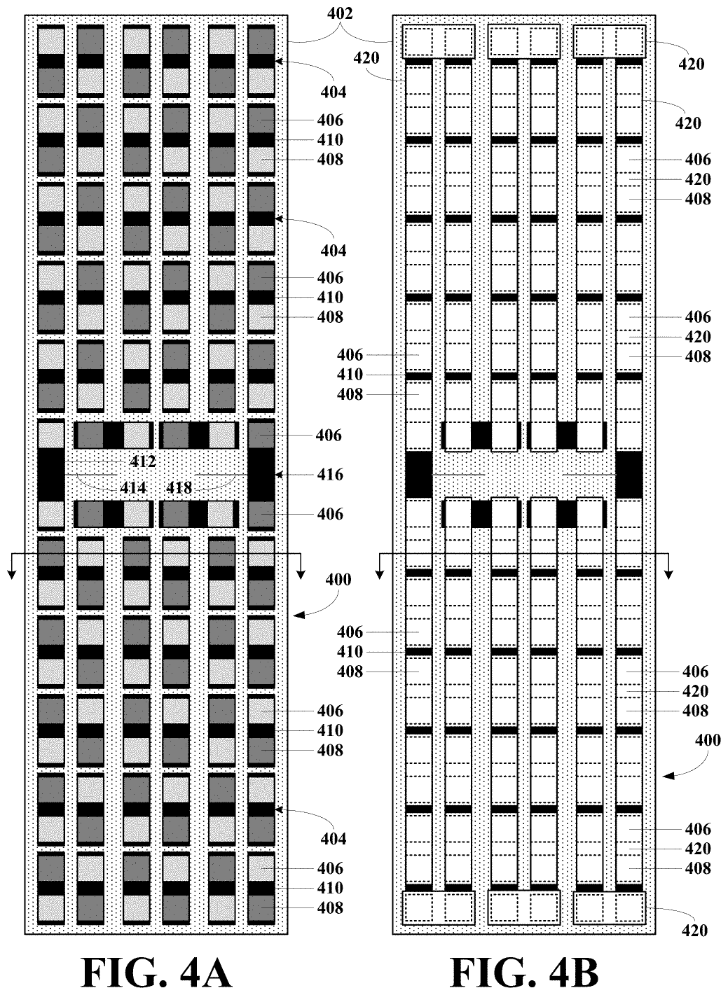

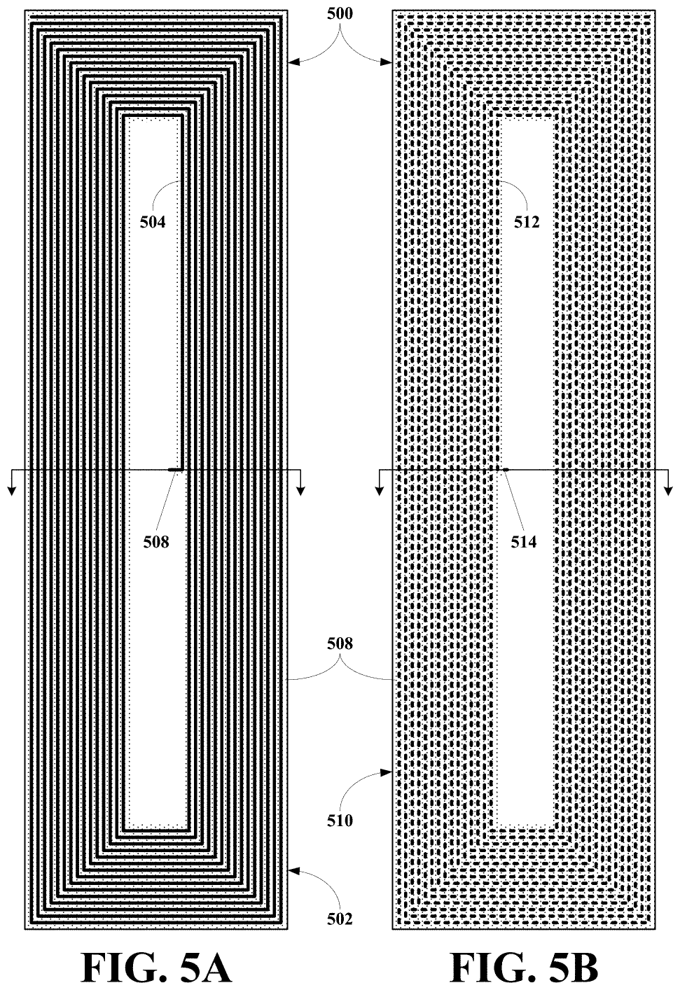

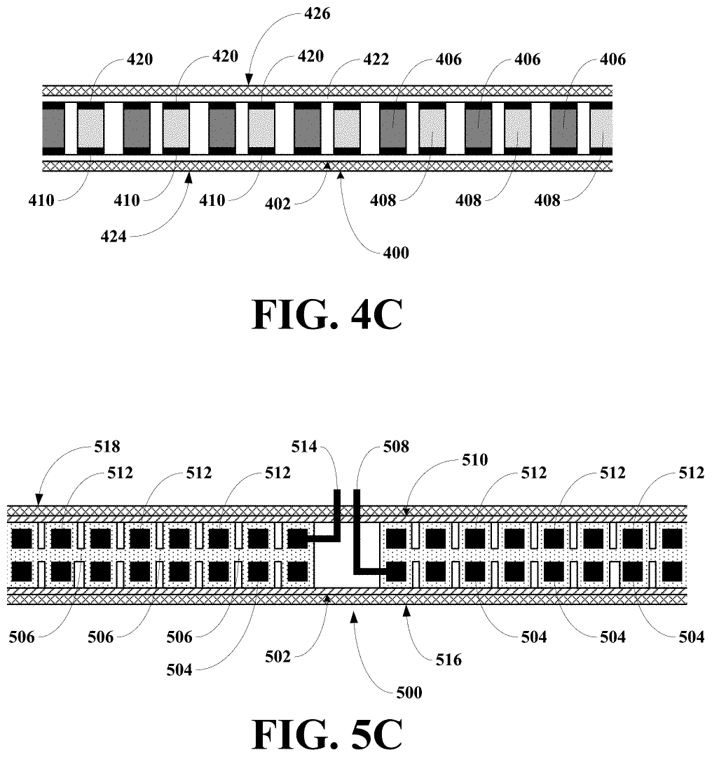

Referring now to FIGS. 4A-C, an embodiment of a power generating member of this disclosure, generally 400, is shown. Looking at FIG. 4A, a top view of the power generating member 400 is shown without a ring contact layer, a skin contact layer, top conductors, and a top layer, which are shown in FIGS. 4B&C. The power generating member 400 includes a backing layer 402 and a plurality of power elements 404 disposed on the backing layer 402. Each of the power elements 404 includes a n-type semiconductor element 406, p-type semiconductor element 408, and a bottom conductor 410. The power generating member 400 also includes a positive terminal 412 having a positive lead 414 and a negative terminal 416 having a negative lead 418. Looking at FIG. 4B, a top view of the power generating member 400 is shown without the ring contact layer and the skin contact layer and shown with the top conductors 420. Looking at FIG. 4C, a cross-sectional view of the member 400 through the cutting line A-A is shown including a plurality of the n-type semiconductor elements 406 and a plurality of the p-type semiconductor elements 408 and a plurality of bottom conductors 410 and top conductors 420 and the bottom layer 402 and the top layer 422 and the skin contact layer 424 and the ring contact layer 426.

Referring now to FIGS. 5A-C, another embodiment of a power generating member of this disclosure, generally 500, is shown. Looking at FIG. 5A, a top view of the power generating member 500 is shown without a ring contact layer, a skin contact layer, a top coil, and a top layer, which are shown in FIGS. 5B&C. The power generating member 500 includes a bottom layer 502 and a bottom coil 504 disposed on the bottom layer 502. The bottom coil 504 is surrounded by an insulating material 506 and includes a bottom lead 508. Looking at FIG. 5B, a top view of the power generating member 500 is shown, without the bottom layer, the bottom coil, the skin contact layer, and the ring contact layer, to include a top layer 510 and a top coil 512 disposed on the top layer 510. The top coil 512 is also surrounded by the insulating material 506 and includes a top lead 514. Looking at FIG. 5C, a cross-sectional view of the member 500 through the cutting line A-A is shown including the bottom layer 502, the bottom coil 504, the bottom lead 508, the insulating material 506, the top layer 510, the top coil 512, the top lead 514, a skin contact layer 516, and a ring contact layer 518. The bottom coil 504 and the top coil 512 are antenna the are configured to derive electric power from a portable electric field generator or RFID chip reader that the wearer may have on their body to produce an electric field sufficient strong for the antenna to absorb enough electric power to power the electronics associated with the lighting apparatus of this disclosure.

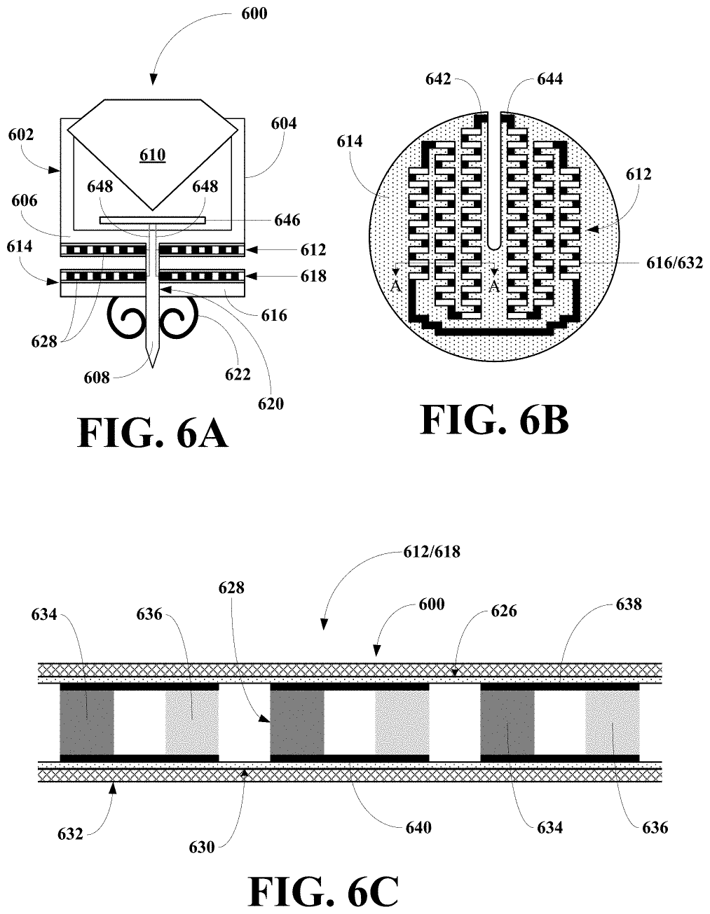

Referring now to FIGS. 6A-C, an embodiment of an earring of this disclosure, generally 600, is shown to include a gem stone mount 602 including gem stone prongs 604, a mount base 606, and post 608. The earring 600 also includes a gem stone 610 mounted in the mount 602. The base 606 also includes a power generating member 612. The earring 600 also includes an earring back 614. The earring back 614 includes a back base 616, a power generating member 618, an aperture 620 for receiving the post 608 and a clipping member 622 to secure the back 614 to the post 608.

The power generating members 612 and 618 include a top adhesive layer 624, a top insulating layer 626, power generating elements 628, a bottom insulating layer 630, and a skin contact layer 632. The top adhesive layer 624 is designed to affix the members 612 and 618 to the mount base 606 and the back base 616, respectively.

Each of the power generating elements 628 include paired n-type semiconductor elements 634 and p-type semiconductor elements 636 electrically connected via top conductors 638 and bottom conductors 640 sandwiched between the two insulating layers 626 and 630. The power generating members 612 and 618 also include a positive lead 642 and a negative lead 644.

The earring 600 also includes a light emitting member 646 in electric communication with the power generating members 612 and 618 via wires 648.

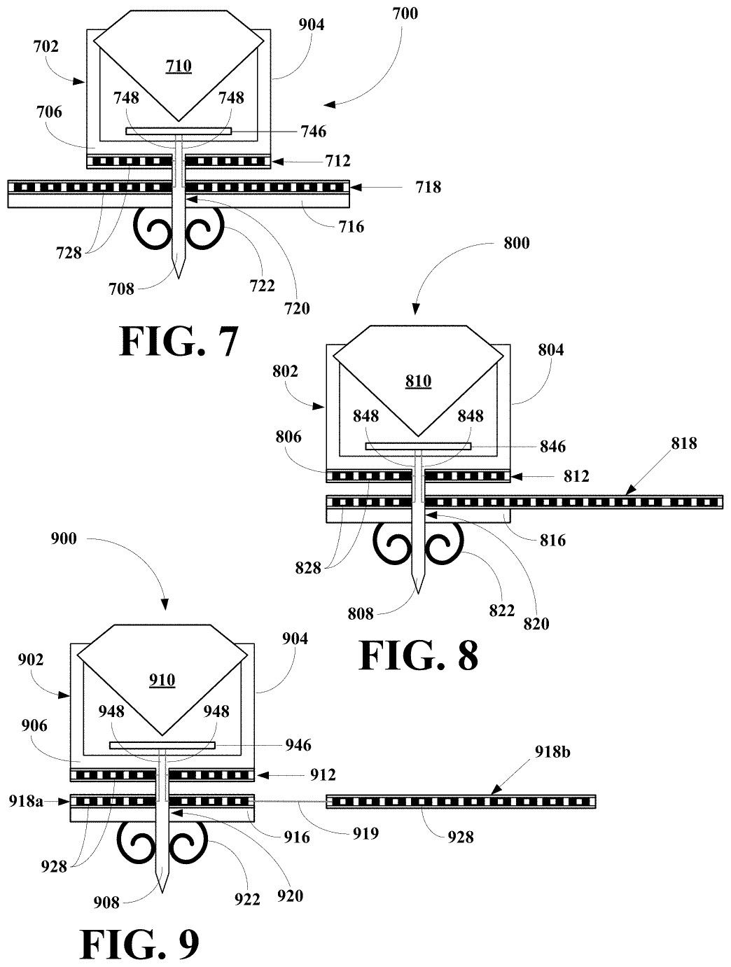

Referring now to FIG. 7, another embodiment of an earring of this disclosure, generally 700, is shown to include a gem stone mount 702 including gem stone prongs 704, a mount base 706, and post 708. The earring 700 also includes a gem stone 710 mounted in the mount 702. The base 706 also includes a power generating member 712. The earring 700 also includes an earring back 714. The earring back 714 includes a back base 716, a power generating member 718, an aperture 720 for receiving the post 708 and a clipping member 722 to secure the back 714 to the post 708. Here the power generating member 718 on the earring back 714 is larger than the power generating member 618 to provide additional power for additional light emitting elements or to power additional functionality.

The power generating members 712 and 718 include a top adhesive layer 724, a top insulating layer 726, power generating elements 728, a bottom insulating layer 730, and a skin contact layer 732. The top adhesive layer 724 is designed to affix the members 712 and 718 to the mount base 706 and the back base 716, respectively. The power generating members 712 and 718 and the power generating elements 728 are as described in FIGS. 6B&C as accompanying text.

The earring 700 also includes a light emitting member 746 in electric communication with the power generating members 712 and 718 via wires 748.

Referring now to FIG. 8, another embodiment of an earring of this disclosure, generally 800, is shown to include a gem stone mount 802 including gem stone prongs 804, a mount base 806, and post 808. The earring 800 also includes a gem stone 810 mounted in the mount 802. The base 806 also includes a power generating member 812. The earring 800 also includes an earring back 814. The earring back 814 includes a back base 816, a power generating member 818, an aperture 820 for receiving the post 808 and a clipping member 822 to secure the back 814 to the post 808. Here the power generating member 818 on the earring back 814 is larger on one side than the power generating member 618 and designed to contact a larger area of the back of a wearer's ear to provide additional power for additional light emitting elements or to power additional functionality.

The power generating members 812 and 818 include a top adhesive layer 824, a top insulating layer 826, power generating elements 828, a bottom insulating layer 830, and a skin contact layer 832. The top adhesive layer 824 is designed to affix the members 812 and 818 to the mount base 806 and the back base 816, respectively. The power generating members 812 and 818 and the power generating elements 828 are as described in FIGS. 6B&C as accompanying text.

The earring 800 also includes a light emitting member 846 in electric communication with the power generating members 812 and 818 via wires 848.

Referring now to FIG. 9, another embodiment of an earring of this disclosure, generally 900, is shown to include a gem stone mount 902 including gem stone prongs 904, a mount base 906, and post 908. The earring 900 also includes a gem stone 910 mounted in the mount 902. The base 906 also includes a power generating member 912. The earring 900 also includes an earring back 914. The earring back 914 includes a back base 916, power generating members 918a&b interconnected by power cable 919, an aperture 920 for receiving the post 908 and a clipping member 922 to secure the back 914 to the post 908. Here the earring back 814 including an additional power generating member 918b that is designed to attach to the back of the wearer's ear, the wearers neck, the wearer's shoulder, or the wearer's back to provide additional power for additional light emitting elements or to power additional functionality.

The power generating members 912 and 918 include a top adhesive layer 924, a top insulating layer 926, power generating elements 928, a bottom insulating layer 930, and a skin contact layer 932. The top adhesive layer 924 is designed to affix the members 912 and 918 to the mount base 906 and the back base 916, respectively. The power generating members 812 and 818 and the power generating elements 828 are as described in FIGS. 6B&C as accompanying text.

The earring 900 also includes a light emitting member 946 in electric communication with the power generating members 912 and 918 via wires 948.

It should be recognized that the light emitting members may including one or more light emitting elements that emit different frequencies of IR, near IR, visible, or UV light. The light emitting members may also include microprocessors for changing which element emit light according to a fixed timing algorithm or a random timing algorithm. Additionally, the earrings, rings, or other jewelry to which the power generating members and light emitting members may be incorporated may include one or more sensors such as thermal sensors, optical sensors, audio sensors, or other sensors. The jewelry may use input from these sensors to change the light being emitted by the light emitting members based on changes in body heat, light from the surroundings, sound from the surrounding, changes in other sensor data or combinations thereof.

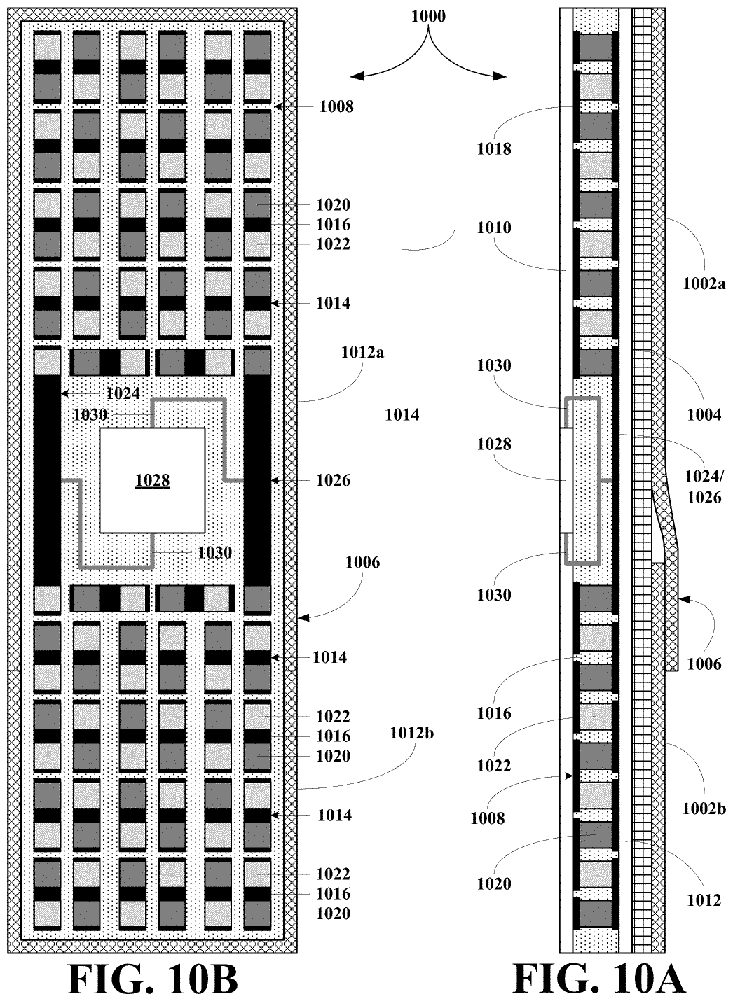

Referring now to FIGS. 10A&B, an embodiment of a jewelry illuminating adhesive construct of this disclosure, generally 1000, is shown to include two release layer 1002a&b covering an adhesive skin contact layer 1004 and including an overlapping region 1006 like a band aid. The construct 1000 also includes a power generating member 1008. The power generating member 1008 includes an top insulating layer 1010, a bottom insulating layer 1012, and a plurality of power generating elements 1014 interposed therebetween. The power generating elements 1008 include bottom conductor layers 1016 and top conductor layers 1018 interconnecting paired n-type semiconductor elements 1020 and p-type semiconductor elements 1022. The power generating member 1006 also includes a positive contact or terminal 1024 and negative contact or terminal 1026. The construct 1000 also includes a light emitting member 1028 in electrical communication with the power generating member terminal 1018 and 1020 via wires 1030. The power generating member 1006 is configured as set forth in FIGS. 4A&B.

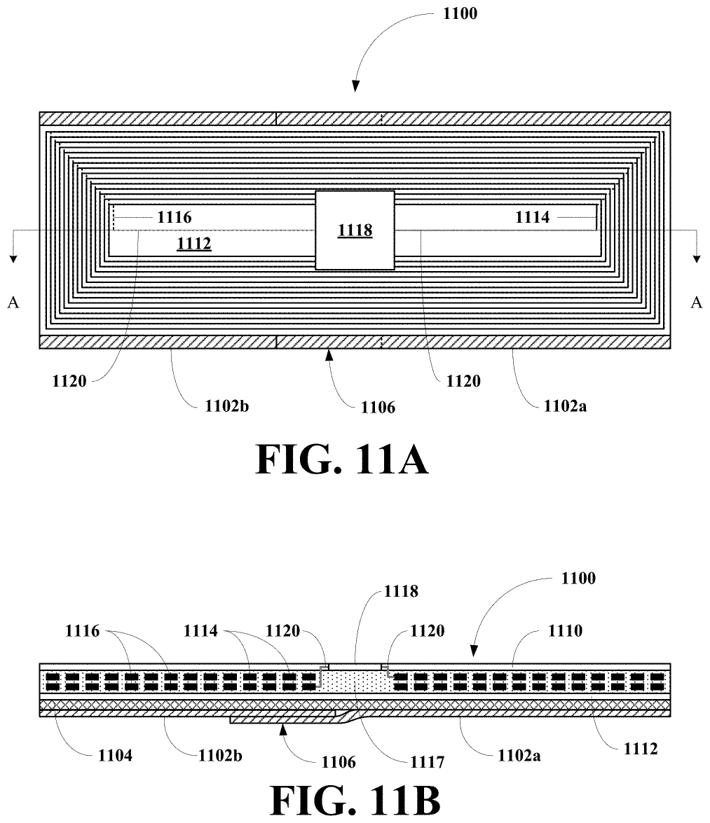

Referring now to FIGS. 11A&B, another embodiment of a jewelry illuminating adhesive construct of this disclosure, generally 1100, is shown to include two release layer 1102a&b covering an adhesive skin contact layer 1104 and including an overlapping region 1106 like a band aid. The construct 1100 also includes a power generating member 1108. The power generating member 1108 includes an top insulating layer 1110, a bottom insulating layer 1112, and a top receiver coil 1114, and a bottom receiver coil 1116 interposed therebetween and surrounded by an insulating material 1117. The construct 1100 also includes a light emitting member 1118 in electrical communication with the top receiver coil 1114 and the bottom receiver coil 1116 via wires 1120. The power generating member 1106 is configured as set forth in FIGS. 5A&B. The bottom coil 1116 and the top coil 1114 are antenna the are configured to derive electric power from a portable electric field generator or RFID chip reader that the wearer may have on their body to produce an electric field sufficient strong for the antenna to absorb enough electric power to power the electronics associated with the lighting apparatus of this disclosure.

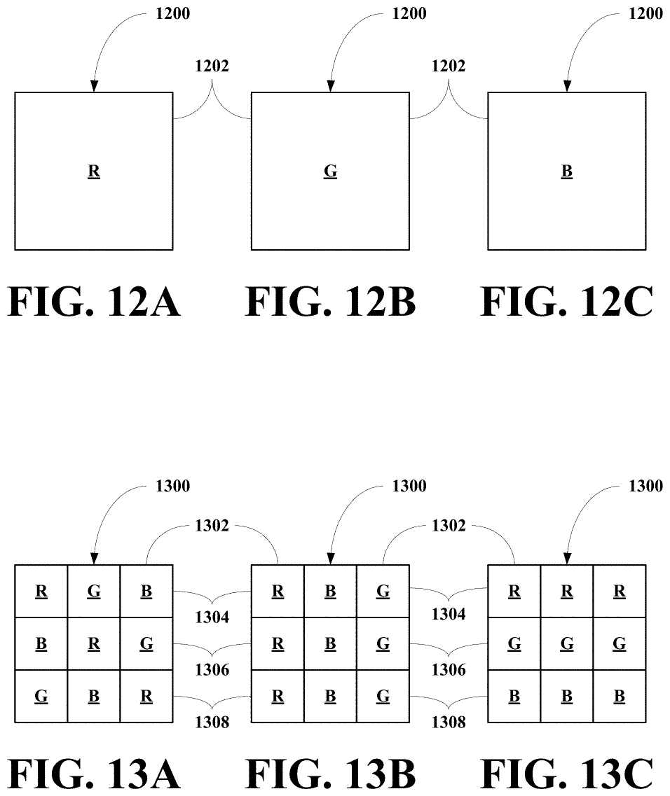

Referring now to FIGS. 12A-C, three different light emitting members, generally 1200, are shown to include a single light emitting element 1202. Looking at FIG. 12A, the element 1202 is red emitting element R; looking at FIG. 12B, the element 1202 is a green emitting element G; and looking at FIG. 12C, the element 1202 is a blue emitting element B.

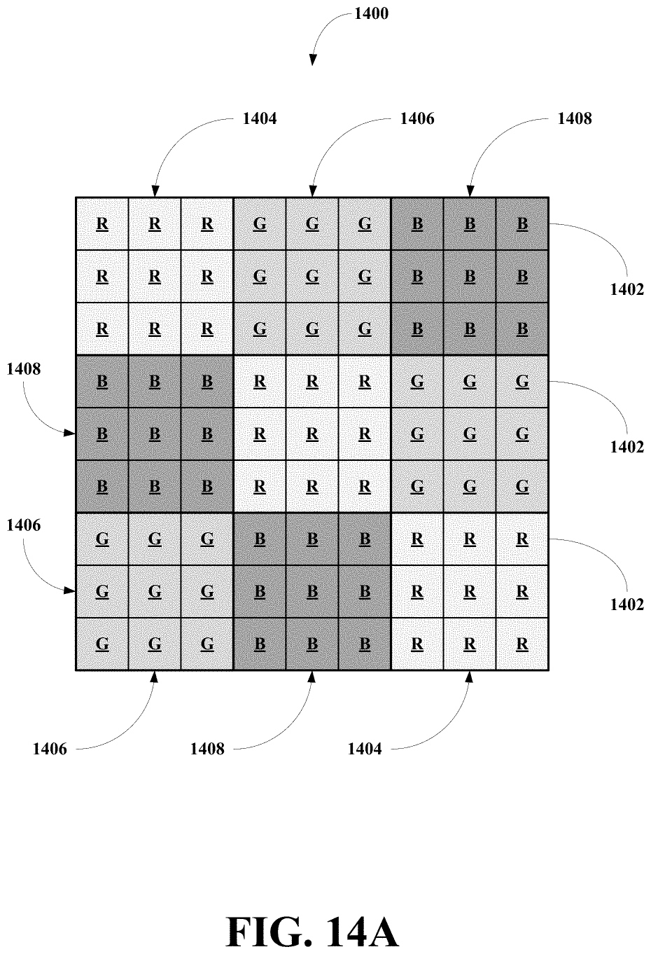

Referring now to FIGS. 13A-C, three different light emitting members, generally 1300, are shown to include nine light emitting elements 1302 distributed in three rows 1304, 1306, and 1308 in a 3×3 matrix pattern.

Looking at FIG. 13A, the first row 1304 includes light emitting elements are R, G, and B. The second row 1306 includes light emitting elements are B, R, and G. The third row 1308 includes light emitting elements are G, B, and R.

Looking at FIG. 13B, the first row 1304 includes light emitting elements are R, G, and B. The second row 1306 includes light emitting elements are R, G, and B. The third row 1308 includes light emitting elements are R, G, and B.

Looking at FIG. 13C, the first row 1304 includes red light emitting elements are R, R, and R. The second row 1306 includes green light emitting elements are G, G, and G. The third row 1308 includes blue light emitting elements are B, B, and B.

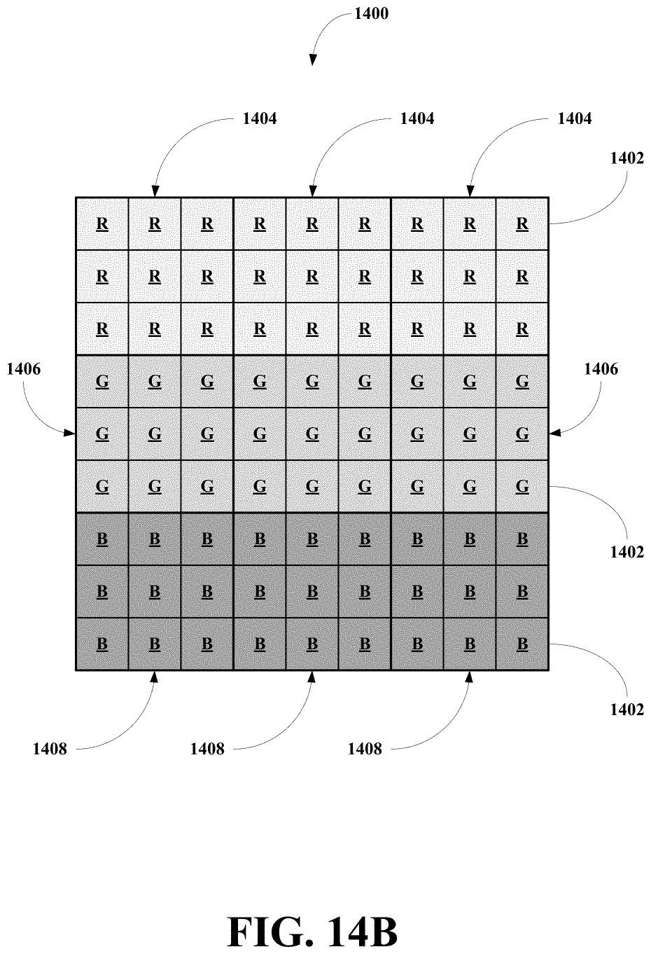

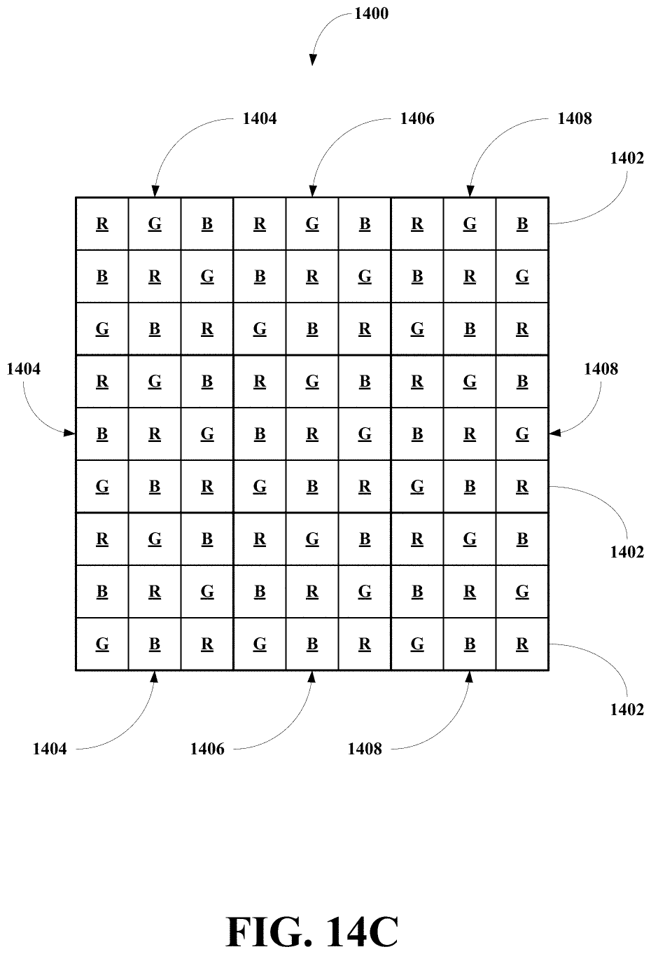

Referring now to FIGS. 14A-C, three different light emitting members, generally 1400, is shown to include light emitting elements 1402 including three different blocks 1404, 1406, and 1408 arranged in a 3×3 block pattern, each of the blocks 1404, 1406, and 1408 includes nine light emitting elements 1402 in a 3×3 light emitting element pattern.

Looking at FIG. 14A, the blocks 1404 comprises nine red light emitting elements R (the 3×3 light emitting element pattern comprises all R light emitting elements), the block 1406 comprises nine green light emitting elements G (the 3×3 light emitting element pattern comprises all G light emitting elements), and the block 1408 comprises nine blue light emitting elements B (the 3×3 light emitting element pattern comprises all B light emitting elements). The 3×3 block pattern comprises a RGB row, a BRG row, and a GBR row.

Looking at FIG. 14B, the blocks 1404 comprises nine red light emitting elements R (the 3×3 light emitting element pattern comprises all R light emitting elements), the block 1406 comprises nine green light emitting elements G (the 3×3 light emitting element pattern comprises all G light emitting elements), and the block 1408 comprises nine blue light emitting elements B (the 3×3 light emitting element pattern comprises all B light emitting elements). The 3×3 block pattern comprises a RRR row, a GGG row, and a BBB row.

Looking at FIG. 14C, the blocks 1404, 1406, and 1408 all comprise the same 3×3 light emitting element pattern comprising a RGB row, a BRG row, and a GBR row and the 3×3 block pattern comprises all nine identical block.

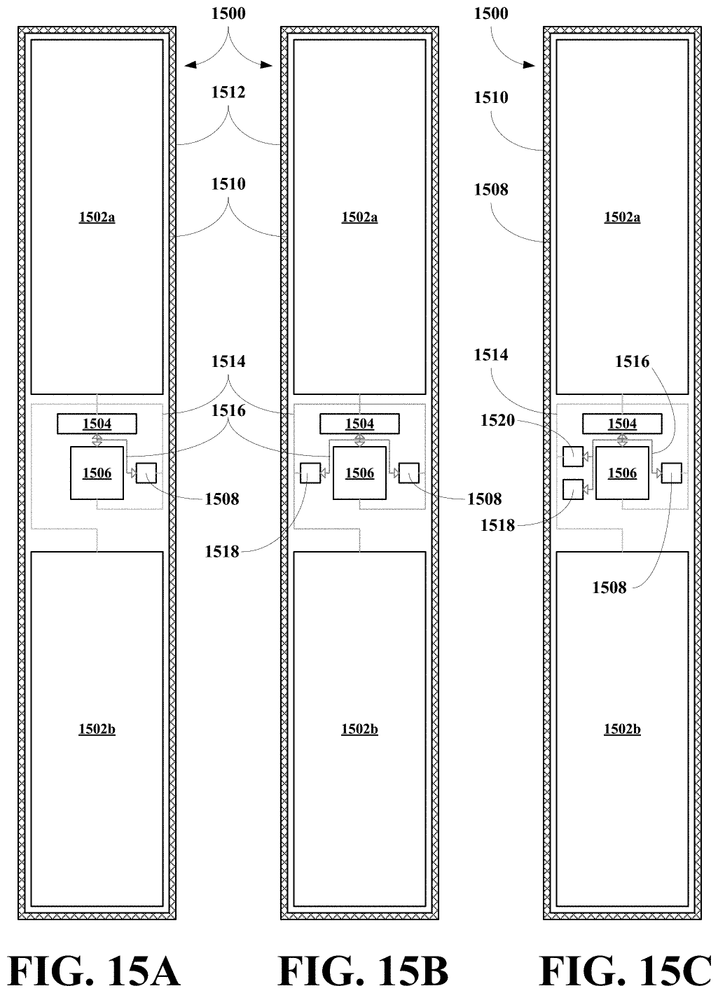

Referring now to FIG. 15A, a jewelry illuminating apparatus, generally 1500, is shown to include two power generating members 1502a&b, a processor 1504, a light emitting member 1506, and a thermal sensor 1508 mounted on a bottom insulating layer 1510 disposed on a skin adhesive contact layer 1512. The processor 1504, light emitting member 1506, and the thermal sensor 1508 are powered by the members 1502a&b via wires 1514. The processor 1504 is in two way communication with the light emitting member 1506 and the thermal sensor 1508 via communication pathways 1516 so that the processor 1504 may receive and send information or commands to the light emitting member 1506 and/or the thermal sensor 1508 over time allowing the processor 1504 to alter an output of the light emitting member 1506 and the light emitting elements comprising the member 1506.

Referring now to FIG. 15B, a jewelry illuminating apparatus, generally 1500, is shown to include the two power generating members 1502a&b, the processor 1504, the light emitting member 1506, the thermal sensor 1508, and a light sensor 1518 mounted the bottom insulating layer 1510 disposed on the skin adhesive contact layer 1512. The light emitting member 1504, the thermal senor 1506, and the light sensor 1518 are powered by the members 1502a&b via the wires 1512. The processor 1504 is in two way communication with the light emitting member 1506, the thermal sensor 1508, and the light sensor 1518 via communication pathways 1516 so that the processor 1504 may receive and send information or commands to the light emitting member 1506, the thermal sensor 1508, and/or the light sensor 1518 over time allowing the processor 1504 to alter an output of the light emitting member 1506 and the light emitting elements comprising the member 1506.

Referring now to FIG. 15C, a jewelry illuminating apparatus, generally 1500, is shown to include the two power generating members 1502a&b, the processor 1504, the light emitting member 1506, the thermal sensor 1508, the light sensor 1518, and a sound sensor 1520 mounted the bottom insulating layer 1508 disposed on the skin adhesive contact layer 1510. The light emitting member 1504, the thermal senor 1506, the light sensor 1518, and the sound sensor 1520 are powered by the members 1502a&b via the wires 1512. The processor 1504 is in two way communication with the light emitting member 1506, the thermal sensor 1508, the light sensor 1518, and the sound sensor 1520 via communication pathways 1516 so that the processor 1504 may receive and send information or commands to the light emitting member 1506, the thermal sensor 1508, the light sensor 1518, and/or the sound sensor 1520 over time allowing the processor 1504 to alter an output of the light emitting member 1506 and the light emitting elements comprising the member 1506.

In the embodiments, of FIG. 15A-C, the processor 1504 (generally a microprocessor or microcontrollers) is in communication with the light emitting member and the sensors and receives data from the sensors and controls when the light emitting member is activated and if the light emitting member includes numerous red, green and blue light emitting elements, then the processor 1504 also controls the type and duration of the light being emitted by the light emitting member so that the light may vary in intensity and color depending on the elements activated. The processor 1504 may be programmed to change the light in synch with the external light, with the external sounds and with the temperature or any combination thereof. Of course, the apparatus/system may include any other sensors such as motion sensors, proximity sensors, etc. all under control of the processor so their data may be used by the processor to vary the light emitting members over time according to a pre-programmed routine or according to random variations utilizing sensor input data.

### SUITABLE COMPONENTS FOR USE IN THE DISCLOSURE

Suitable jewelry for used in this disclosure include, without limitation, rings, brooches, pendants, necklaces, bracelets, earrings, watches, or any other jewelry. The jewelry may include one or more gem stones therein.

Suitable gem stones for use in this disclosure include, without limitation, Actinolite, Nephrite, Adamite, Aegerine, Afghanite, Agate, IrisAgate, Onyx, Sardonyx, Agrellite, Albite, Alunite, Amblygonite, Analcime, Anatase, Andalusite, Chiastolite, Andesine, Anglesite, Anhydrite, Annabergite, Antigorite, Bowenite, Apatite, Apophyllite, Aragonite, Arfvedsonite, Astrophyllite, Atacamite, Austinite, Ferroaxinite, Magnesioaxinite, Manganaxinite, Tinzenite, Azurite, Baryte, Bastnaesite, Bayldonite, Benitoite, Aquamarine, Bixbite, Emerald, Goshenite, Goldenberyl, Heliodor, Morganite, Beryllonite, Beudantite, Biotite, Boleite, Boracite, Bornite, Brazilianite, Bronzite, Brookite, Brucite, Bustamite, Bytownite, Calcite, Manganocalcite, Caledonite, Cancrinite, Vishnevite, Carletonite, Carnallite, Carnelian, Cassiterite, Cavansite, Celestite (celestine), Cerussite, Chabazite, Chalcopyrite, Chambersite, Charlesite, Charoite, Childrenite, Chloromelanite, Chondrodite, Chrysoberyl, Alexandrite, Cymophane, Chromite, Chrysocolla, Chrysoprase, Chrysotile, Cinnabar, Citrine, Clinochlore, Clinohumite, Clinozoisite, Clintonite, Cordierite, Iolite, Corundum, Ruby, Sapphire, Covellite, Creedite, Cryolite, Cuprite, Danburite, Datolite, Diamond, Bort, Diaspore, Diopside, Dioptase, Dolomite, Dravite, Dumortierite, Elbaite, Emerald, Trapicheemerald, Enstatite, Bronzite, Hypersthene, Eosphorite, Epidote, Piemontite, Erythrite, Esperite, Ettringite, Euclase, Eudialyte, Fayalite, Ferroaxinite, Andesine, Albite, Anorthite, Anorthoclase, Amazonite, Bytownite, Celsian, Labradorite, Microcline, Moonstone, Orthoclase, Sanidine, Sunstone, Fluorapatite, Fluorapophyllite, Fluorite, Forsterite, Gahnite, Pyralspite, Almandine, Pyrope, Spessartine, Ugrandite, Andradite, Demantoid, Melanite, Topazolite, Grossular, Hessonite, Hydro grossular, Tsavorite, Uvarovite, Almandine-Pyrope, Rhodolite, Andradite-Grossular, Grandite, Pyrope-Almandine-Spessartine, Malaiagarnet, Pyrope-Spessartine, Umbalite, Gaspeite, Gaylussite, Gibbsite, Glaucophane, Goethite, Goosecreekite, Grandidierite, Gypsum, Gyrolite, Hackmanite, Halite, Hambergite, Hanksite, Hardystonite, Hauyne, Hematite, Hemimorphite, Herderite, Hexagonite, Hibonite, Hiddenite, Hodgkinsonite, Howlite, Humite, Hypersthene, Iolite, Jade, Jadeite, Nephrite, Jasper, Radiolarite, Jeremejevite, Kainite, Kornerupine, Kunzite, Kutnohorite, Kurnakovite, Kyanite, Langbeinite, LapisLazuli, Larimar, Lawsonite, Lazurite, Legrandite, Lepidolite, Leucite, Leucophanite, Linarite, Lizardite, Londonite, Ludlamite, Magnesite, Malachite, Marialite-Meionite, Wernerite, Mimetite, Moissanite, Moonstone, Adularia, Rainbow, Mottramite, Muscovite, Fuchsite, Musgravite, Narsarsukite, Natrolite, Nepheline, Neptunite, Nickeline, Nuummite, Opal, Painite, Papagoite, Pargasite, Pectolite, Larimar, Peridot, Periclase, Petalite (castorite), Pezzottaite, Phenakite, Phlogopite, Phosgenite, Phosphophyllite, Piemontite, Pietersite, Plumbogummite, Pollucite, Polyhalite, Poudretteite, Prasiolite, Prehnite, Prismatine, Proustite, Pumpellyite, Chlorastrolite, Purpurite, Pyrite, Pyrargyrite, Pyromorphite, Pyrrhotite, Quartz, Amethyst, Ametrine, Chalcedony, Agate, IrisAgate, Onyx, Sardonyx, Bloodstone (Heliotrope), Carnelian, ChromeChalcedony, Chrysoprase, DendriticAgate, MossAgate, Fireagate (Iridescentvar.), Jasper, PetrifiedWood, Sard, Citrine, Druzy, Flint, Milkyquartz, Prasiolite, Rosequartz, Rockcrystal, Smokyquartz, Ruby, Richterite, Rosequartz, Rhodizite, Rhodochrosite, Riebeckite, Crocidolite, Rosasite, Rutile, Sapphire, Padparadscha, Sard, Sardonyx, Scapolite, Scheelite, Schorl, Scolecite, Scorodite, Selenite, Sellaite, Senarmontite, Sérandite, Seraphinite, Serendibite, Antigorite, Bowenite, Chrysotile, Lizardite, Stichtite, Shattuckite, Shigaite, Shortite, Shungite, Siderite, Sillimanite, Sinhalite, Smithsonite, Sodalite, Hackmanite, Sperrylite, Spessartite, Spinel, Ceylonite, Spodumene, Hiddenite, Kunzite, Triphane, Stichtite, Staurolite, Sulfur, Stolzite, Sugilite, Bustamite, Richterite, Sylvite, Taaffeite, Tantalite, Thomsonite, Thaumasite, Tinaksite, Titanite (sphene), Topaz, Achroite, Canary, Fluor-liddicoatite, Indicolite, Olenite, Paraiba, Rossmanite, Rubellite, Tremolite, Hexagonite, Tugtupite, Turquoise, Vanadinite, Variscite, Vayrynenite, Vesuvianite (idocrase), Californite, Villiaumite, Vlasovite, Wavellite, Weloganite, Willemite, Wulfenite, Xonotlite, Zektzerite, Zeolites, Analcite, Apophyllite, Chabazite, Goosecreekite, Natrolite, Stellarite, Thomsonite, Zincite, Zinnwaldite, Zircon, Jacinth, Zoisite, Tanzanite, Thulite, Zulta, or mixtures and combinations thereof.

Suitable metal for the energizing coils include, without limitation, copper, silver, gold, platinum, other noble metals, or mixtures and combinations thereof.

Suitable processing units or processors include, without limitation, any digital processing unit (DPU) capable of accepting input from a singular or plurality of devices or objects and converting at least some of the input into output designed to select and/or control attributes of one or more of the devices or objects. Exemplary examples of such DPUs include, without limitation, microprocessor, microcontrollers, or the like manufactured by Intel, Motorola, Erricsson, HP, Samsung, Hitachi, NRC, Applied Materials, AMD, Cyrix, Sun Microsystem, Philips, National Semiconductor, Via Electronics, Qualcomm, or any other manufacture of microprocessors or microcontrollers or any analog processing units (APUs) include, without limitation, any analog processing unit capable of accepting input from a singular or a plurality of devices or objects and converting at least some of the input into output designed to control attributes of one or more of the devices or objects. Such analog devices are available from manufacturers such as Analog Devices Inc.

Suitable motion sensing apparatus or motion sensors include, without limitation, motion sensors of any form such as digital cameras, optical scanners, optical roller ball devices, touch pads, inductive pads, capacitive pads, holographic devices, laser tracking devices, thermal devices, EMF sensors, wave form sensors, any other device capable of sensing motion, changes in EMF, changes in wave form, or the like or arrays of such devices or mixtures or combinations thereof. The motion sensors may be optical sensors, acoustic sensors, thermal sensors, optoacoustic sensors, any other sensor or combination of sensors that senses movement or changes in movement, or mixtures or combinations thereof. The sensors may be digital, analog or a combination of digital and analog. For camera systems, the systems may sense motion within a zone, area or volume in front of the lens. Optical sensors may operate in any region of the electromagnetic spectrum including, without limitation, RF, microwave, near IR, IR, far IR, visible, UV or mixtures or combinations thereof. Acoustic sensor may operate over the entire sonic range which includes the human audio range, animal audio ranges, or combinations thereof. EMF sensors may be used and operate in any region of a discernable wavelength or magnitude where motion can be discerned. Moreover, LCD screen(s) may be incorporated to identify which devices are chosen or the temperature setting, etc. Moreover, the interface may project a virtual control surface and sense motion within the projected image and invoke actions based on the sensed motion. The motion sensor associated with the interfaces of this invention can also be acoustic motion sensor using any acceptable region of the sound spectrum. A volume of a liquid or gas, where a user's body part or object under the control of a user may be immersed, may be used, where sensors associated with the liquid or gas can discern motion. Any sensor being able to discern differences in transverse, longitudinal, pulse, compression or any other waveform could be used to discern motion and any sensor measuring gravitational, magnetic, electro-magnetic, or electrical changes relating to motion or contact while moving (resistive and capacitive screens) could be used. Of course, the interfaces can include mixtures or combinations of any known or yet to be invented motion sensors.

Suitable body heat electrical generating films include, without limitation, films made by CharlieTech, Fujifilm, Fuitsu Laboratories Ltd., or other similar body heat electrical generating films.

Suitable semiconductors include, without limitation, silicon (Si), germanium (Ge), gallium arsenide (GaAs), and/or indium phosphide (InP).

Suitable n-type semiconductors include, without limitation, any semiconductor including or doped with a pentavalent impurity such as phosphorus (P), arsenic (As), antimony (Sb), and/or bismuth (Bi).

Suitable p-type semiconductors include, without limitation, any semiconductor including or doped with a trivalent impurity such as boron (B), aluminum (Al), and/or gallium (Ga).

Suitable light emitting elements include, without limitation, inorganic light emitting diodes (LEDs), organic light emitting diodes (OLEDs), polymeric light-emitting diodes (PLEDs), ultraflexible PLED, and any mixture or combination of these light emitting elements.

Exemplary inorganic LEDs include, without limitation, Ultra Red (660 nm) GaAlAs/GaAlAs LEDs, Super Red (λ=633 nm) AlGaInP LEDs, Super Orange (λ=612 nm) AlGaInP LEDs, Orange (λ=605) GaAsP/GaP LEDs, Yellow (λ=585) GaAsP/GaP LEDs, Pure Green (λ=555) GaP/GaP, Super Blue (λ=470) GaN/SiC, Blue Violet (λ=430) GaN/SiC, or combinations thereof. There are two main classes of organic light-emitting diodes: OLEDs (small-molecule based light emitting diodes) and PLEDs (polymer light emitting diodes). A typical double-heterostructure small-molecule OLED consists of three organic layers sandwiched between electrodes. The organic layers adjacent to cathode and anode are the electron transport layer (ETL) and the hole transport layer (HTL), respectively. Emissive layer (EML) usually consists of light-emitting dyes or dopants dispersed in a suitable host material. Often the EML is the same material as the HTL or ETL.

Exemplary host materials include, without limitation, tris(8-hydroxyquinolinato)aluminium (Alq₃), 4,4′-bis(9H-carbazol-9-yl)biphenyl, 4,4′-bis(2,2-diphenylvinyl)biphenyl, 9,9′-Bianthracene, 4,4′-bis(9H-carbazol-9-yl)biphenyl (purified by sublimation), 2,6-bis[3-(9H-carbazol-9-yl)phenyl]pyridine, 4,4′-bis(9H-carbazol-9-yl)-2,2′-dimethylbiphenyl, 2,8-bis(9H-carbazol-9-yl)dibenzothiophene, 2,6-bis(9H-carbazol-9-yl)pyridine, 9,9-bis[4-(1-pyrenyl)phenyl]fluorene, 9,10-bis(4-methoxyphenyl)anthracene, 4,4′-bis(2,2-diphenylvinyl)biphenyl (purified by sublimation), bis[2-[(oxo)diphenylphosphino]phenyl] ether, bis[2-[(oxo)diphenylphosphino]phenyl] ether (purified by sublimation) 2,8-Bis(diphenylphosphoryl)dibenzo[b,d]furan, 9,10-Diphenylanthracene, 9,10-di(1-naphthyl)anthracene 1,3-di-9-carbazolylbenzene (purified by sublimation), 9,10-di(2-naphthyl)anthracene, 9,10-diphenylanthracene (purified by sublimation), 3,3′-di(9H-carbazol-9-yl)-1,1′-biphenyl, 9,9′-diphenyl-9H,9′H-3,3′-bicarbazole, 3,3″-di(9H-carbazol-9-yl)-1,1′:3′,1″-terphenyl, 9-[3-(dibenzofuran-2-yl)phenyl]-9H-carbazole, 1,4-di(1-pyrenyl)benzene, 2,7-di(1-pyrenyl)-9,9′-spirobi[9H-fluorene], 9,10-di(1-naphthyl)anthracene (purified by sublimation), 9,10-di(2-naphthyl)anthracene (purified by sublimation), 3,3′-di(dibenzothiophen-4-yl)-1,1′-biphenyl, 2-methyl-9,10-di(2-naphthyl)anthracene, 4-(1-naphthyl)-3,5-diphenyl-1,2,4-triazole, 9-phenyl-3,6-bis[4-(1-phenylbenzimidazol-2-yl)phenyl]carbazole, 2-(9,9′-spirobi[fluoren]-2-yl)-4,6-diphenyl-1,3,5-triazine, tris(8-quinolinolato)aluminum, 1,3,5-tri(9H-carbazol-9-yl)benzene (purified by sublimation), tris(8-quinolinolato)aluminum (purified by sublimation), 4,4′,4″-tri-9-carbazolyltriphenylamine (purified by sublimation), 4,4′,4″-tri-9-carbazolyltriphenylamine, 1,3,5-tri(1-naphthyl)benzene, 9,9′,10,10′-tetraphenyl-2,2′-bianthracene, 2,2″:7″,2″″-ter-9,9′-spirobi[9H-fluorene], or any mixture or combination thereof.

Exemplary hole transport materials include, without limitation, N,N-bis(3-methylphenyl)-N,N-diphenylbenzidine (TPD), 1,1-bis[4-[N,N-di(p-tolyl)amino]phenyl]cyclohexane, 4,4′-bis[di(3,5-xylyl)amino]-4″-phenyltriphenylamine, 4,4′-bis[N-(1-naphthyl)-N-phenylamino]-4″-phenyltriphenylamine, 1,1-bis[4-[N,N-di(p-tolyl)amino]phenyl]cyclohexane (purified by sublimation), N,N′-bis(4-methoxy-2-methylphenyl)-N,N′-diphenylbenzidine, 3,3′-bis[di(p-tolyl)amino]biphenyl, 2,7-bis[N-(1-naphthyl)anilino]-9,9′-spirobi[9H-fluorene], 2,7-bis[N-(m-tolyl)anilino]-9,9′-spirobi[9H-fluorene], 3,3′-bi[1,4]benzoxazino[2,3,4-kl]phenoxazine, 7,7′-bi[1,4]benzoxazino[2,3,4-kl]phenoxazine, 2,7-bis[N-(1-naphthyl)anilino]-9,9-dimethylfluorene, 2,7-bis[N,N-bis(4-methoxyphenyl)amino]-9,9-spirobi[9H-fluorene], N,N′-bis(9,9-dimethyl-9H-fluoren-2-yl)-N,N′-diphenylbenzidine, 9,9-bis[4-[di(2-naphthyl)amino]phenyl]fluorene, 9,9-bis[4-[N-(1-naphthyl)anilino]phenyl]fluorene, N,N-bis(9,9-dimethyl-9H-fluoren-2-yl)aniline, N,N′-bis[4-(diphenylamino)phenyl]-N,N′-di(1-naphthyl)benzidine, N,N′-bis[4-(diphenylamino)phenyl]-N,N′-diphenylbenzidine, N,N′-Bis(4-methoxy-2-methylphenyl)-N,N′-diphenylbenzidine (purified by sublimation), N,N′-Bis[4-di(m-tolyl)aminophenyl]-N,N′-diphenylbenzidine, phthalocyanine chloroaluminum, cobalt(II) Phthalocyanine (purified by sublimation), N,N′-diphenyl-N,N′-di(m-tolyl)benzidine, N,N′-diphenyl-N,N′-di(m-tolyl)benzidine (purified by sublimation), N,N′-di-1-naphthyl-N,N′-diphenylbenzidine (purified by sublimation), N,N′-di-2-naphthyl-N,N′-diphenylbenzidine, 2,6-diphenylbenzo[1,2-b:4,5-b′]difuran, 10,15-dihydro-5,5,10,10,15,15-hexamethyl-5H-tribenzo[a,f,k]trindene, N,N′-diphenyl-N,N′-di(p-tolyl)benzidine, N,N′-di-1-naphthyl-N,N′-di-2-naphthylbenzidine, N,N′-diphenyl-N,N′-bis[4′-(diphenylamino)biphenyl-4-yl]benzidine, N,N′-diphenyl-N,N′-bis(p-tolyl)-1,4-phenylenediamine, 9,9-dimethyl-2,7-bis[N-(m-tolyl)anilino]fluorene, N,N′-di(4-biphenylyl)-N,N′-diphenylbenzidine, N,N′-di(2-naphthyl)-N,N′-diphenyl-1,4-phenylenediamine, N,N′-diphenyl-N,N′-di(m-tolyl)-1,4-phenylenediamine, N,N′-di-1-naphthyl-N,N′-diphenylbenzidine, N,N′-di(9-phenanthrenyl)-N,N′-diphenylbenzidine, N,N′-di(1-naphthyl)-N,N′,9,9-tetraphenyl-9H-fluorene-2,7-diamine, 9-ethylcarbazole-3-carboxaldehyde N-methyl-N-phenylhydrazone, 9-ethylcarbazole-3-carboxaldehyde diphenylhydrazone, 9-ethylcarbazole-3-carboxaldehyde N-benzyl-N-phenylhydrazone, Cobalt(II) phthalocyanine, Tin(IV) phthalocyanine dichloride, copper(II) Phthalocyanine (α-form), Copper(II) phthalocyanine (β-form), Pigment Blue 15 (purified by sublimation), N,N,N′,N′-tetraphenylbenzidine, 4,4′,4″-tris[phenyl(m-tolyl)amino]triphenylamine, N,N,N′,N′-tetrakis(p-tolyl)benzidine, titanyl phthalocyanine (purified by sublimation), tris[4-(2-thienyl)phenyl]amine, N,N,N′,N′-tetrakis(4-biphenylyl)benzidine, 4,4′,4″-tris(diphenylamino)triphenylamine, 4,4′,4″-tris[2-naphthyl(phenyl)amino]triphenylamine, N,N,N′,N′-tetrakis(p-tolyl)benzidine (purified by sublimation), N,N,N′,N′-Tetraphenylbenzidine (purified by sublimation), N,N,N′,N′-tetra(2-naphthyl)benzidine, N,N,N′,N′-tetrakis(4-methoxyphenyl)benzidine, N,N,N′,N′-tetraphenyl-1,4-phenylenediamine, tris(4-biphenylyl)amine, tris[4′-(2-thienyl)-4-biphenylyl]amine, 1,3,5-tris[4-(diphenylamino phenyl]benzene, 1,3,5 -tris[4-[bis(4-methoxyphenyl)amino]phenyl]benzene, 1,3,5-tris[4-(9-carbazolyl)phenyl]benzene, 1,3,5-tris(4-biphenylyl)benzene, 1,3,5-tris(4′-fluorobiphenyl-4-yl)benzene, 2,2′,7,7′-tetrakis(diphenylamino)-9,9′-spirobi[9H-fluorene],N,N,N′,N′-tetra([1,1′-biphenyl]-4-yl)[1,1′:4′,1″-terphenyl]-4,4″-diamine, N,N,N′,N′-tetraphenyl[1,1′:4′,1″:4″,1′″-quaterphenyl]-4,4′″-diamine, tris(4-biphenylyl)amine (purified by sublimation), or any mixture or combination thereof.

Exemplary electron transport materials include, without limitation, 2-(4-biphenyl)-5-(4-tert-butylphenyl)-1,3,4-oxadiazo (PBD), 2,5-bis(5-tert-butyl-2-benzoxazolyl)thiophene, 4,4′-bis(5-methyl-2-benzoxazolyl)stilbene, 2-(4-tert-butylphenyl)-5-(4-biphenylyl)-1,3,4-oxadiazole, 4,4′-bis(5-methyl-2-benzoxazolyl)stilbene (purified by sublimation), bathocuproine (purified by sublimation), bathophenanthroline (purified by sublimation), 2-(4-tert-Butylphenyl)-5-(4-biphenylyl)-1,3,4-oxadiazole (purified by sublimation), 2,5-bis(5-tert-butyl-2-benzoxazolyl)thiophene (purified by sublimation), 2,5-bis(2,2′-bipyridin-6-yl)-1,1-dimethyl-3,4-diphenylsilole, 1,3-bis[5-(4-tert-butylphenyl)-2-[1,3,4]oxadiazolyl]benzene, 4,4′-bis(4,6-diphenyl-1,3,5-triazin-2-yl)biphenyl (This product is unavailable in the U.S.), bathocuproine, bathophenanthroline, 2,5-diphenyl-1,3,4-oxadiazole, 2,5-di(1-naphthyl)-1,3,4-oxadiazole, 3,5-di(1-pyrenyl)pyridine, 1,1,2,3,4,5-hexaphenylsilole, 1,2,3,4,5-pentaphenyl-1,3-cyclopentadiene, (8-quinolinolato)lithium, 1,2,3,4 -tetraphenyl-1,3-cyclopentadiene, tris(8-quinolinolato)aluminum, tris(8-quinolinolato)aluminum (purified by sublimation), 2,4,6-tri(9H-carbazol-9-yl)-1,3,5-triazine (purified by sublimation), 2,4,6-triphenyl-1,3,5-triazine, 2,4,6-triphenyl-1,3,5-triazine (purified by sublimation), 1,3,5-tris(1-phenyl-1H-benzimidazol-2-yl)benzene, 2,4,6-tri([1,1′-biphenyl]-4-yl)-1,3,5-triazine, 1,2,3,4-tetraphenyl-1,3-cyclopentadiene (purified by sublimation), or any mixture or combination thereof.

Exemplary hole injection materials include, without limitation, 1,3-bis(triphenylsilyl)benzene 97%, dntpd 99%, molybdenum trioxide/pedot:pss ink viscosity 3 cp, organic conductive inks kit, pedot-iron(iii) oxide preparation, PLEXCORE® oc aq-1250 organic conductive ink, polyaniline (emeraldine salt) average mw>15,000, powder (infusible), 3-100 μm particle size, poly(3,4-ethylenedioxythiophene), bis-poly(ethyleneglycol), lauryl terminated 0.7 wt. % (dispersion in nitromethane), poly(3,4-ethylenedioxythiophene), bis-poly(ethyleneglycol), lauryl terminated 0.8 wt. % (dispersion in 1,2-dichlorobenzene), contains p-toluenesulfonate as dopant, poly(3,4-ethylenedioxythiophene), bis-poly(ethyleneglycol), lauryl terminated 0.7 wt. % (dispersion in nitromethane), contains p-toluenesulfonate as dopant, poly(3,4-ethylenedioxythiophene), bis-poly(ethyleneglycol), lauryl terminated 0.8 wt. % (dispersion in propylene carbonate), contains perchlorate as dopant, poly(3,4-ethylenedioxythiophene)-block-poly(ethylene glycol) solution 1 wt % dispersion in nitromethane, contains perchlorate as dopant, poly(3,4-ethylenedioxythiophene)poly(styrenesulfonate) high-conductivity grade, poly(3,4-ethylenedioxythiophene)poly(styrenesulfonate) 1.3 wt % dispersion in H₂O, conductive grade, poly(3,4-ethylenedioxythiophene)-poly(styrenesulfonate) 3.0-4.0% in H₂O, high-conductivity grade, poly(3,4-ethylenedioxythiophene)-poly(styrenesulfonate) 2.8 wt % dispersion in H₂O, low-conductivity grade, poly(3,4-ethylenedioxythiophene), tetramethacrylate end-capped solution 0.5 wt. % (dispersion in propylene carbonate), contains p-toluenesulfonate as dopant, poly(3,4-ethylenedioxythiophene), tetramethacrylate end-capped solution 0.5 wt. % (dispersion in nitromethane), contains p-toluenesulfonate as dopant, poly(thiophene-3-[2-(2-methoxyethoxy)ethoxy]-2,5-diyl), sulfonated solution 2% in ethylene glycol monobutyl ether/water, 3:2, electronic grade, tetracyanoethylene 98%, 7,7,8,8-tetracyanoquinodimethane 98%, 2,3,5,6-tetrafluoro-7,7,8,8-tetracyanoquinodimethane 97%, 4,4,4-tris[phenyl(m-tolyl)amino]triphenylamine 98.0%, tungsten oxide (WO₃₋ₓ) nanoparticle ink, or any mixture or combination thereof.

Additional exemplary hole injection materials include, without limitation, 2,3,8,9,14,15-hexafluorodiquinoxalino[2,3-a:2′,3′-c]phenazine (HATNA-F6), N1,N1′-(biphenyl-4,4′-diyl)bis(N1-phenyl-N4,N4-di-m-tolylbenzene-1,4-diamine) (DNTPD), N,N,N′,N′-tetrakis-(4-methoxyphenyl)benzidine (MeO-TPD), 4,4′,4″-tris(N-(naphthalen-2-yl)-N-phenyl-amino)triphenylamine (2T-NATA), 4,4′,4″-tris(N-3-methylphenyl-N-phenyl-amino)triphenylamine (m-MTDATA), 4,4′,4″-tris(N,N-diphenyl-amino)triphenylamine (NATA), 4,4′,4″-tris(N-(naphthalen-1-yl)-N-phenyl-amino)triphenylamine (1T-NATA), 4,4′,4″-tris(N-(naphthalen-2-yl)-N-phenyl-amino)triphenylamine (2T-NATA), 4,4′,4″-tris(N-3-methylphenyl-N-phenyl-amino)triphenylamine (m-MTDATA), 2,3,5,6-tetrafluoro-7,7,8,8-tetracyano-quinodimethane (F4-TCNQ), pyrazino[2,3-f][1,10]phenanthroline-2,3-dicarbonitrile (PPDN), N,N,N′,N′-tetrakis(4-methoxyphenyl)benzidine (MeO-TPD), 2,7-bis[N,N-bis(4-methoxy-phenyl)amino]-9,9-spirobifluorene (MeO-Spiro-TPD), 2,2′-Bis[N,N-bis(4-methoxy-phenyl)amino]-9,9-spirobifluorene (2,2′-MeO-Spiro-TPD), N,N′-diphenyl-N,N′-di-[4-(N,N-di-p-tolyl-amino)phenyl]benzidine (NTNPB), N,N′-diphenyl-N,N′-di-[4-(N,N-diphenyl-amino)phenyl]benzidine (NPNPB), N4,N4′-(biphenyl-4,4′-diyl)bis(N4,N4′,N4′-triphenylbiphenyl-4,4′-diamine)(TPT1), N1,N1′-(biphenyl-4,4′-diyl)bis(N1-phenyl-N4,N4-di-m-tolylbenzene-1,4-diamine)(DNTPD), diquinoxalino[2,3-a:2′,3′-c]phenazine (HATNA), 2,3,8,9,14,15-hexachlorodiquinoxalino[2,3-a:2′,3′-c]phenazine (HATNA-Cl6), (HATNA-F6) 2,3,8,9,14,15-hexafluorodiquinoxalino[2,3-a:2′,3′-c]phenazine, N2,N2′-(9,9-dioctyl-9H-fluorene-2,7-diyl)bis(9,9-dimethyl-N2,N7,N7-triphenyl-9H-fluorene-2,7-diamine (3FTPD-C8), 2-(2-methoxyphenyl)-1,3-dimethyl-1H-benzoimidazol-3-ium iodide (MeOPBI), 2,2′-(naphthalene-2,6-diylidene)dimalononitrile (TNAP), N4,N4′-(biphenyl-4,4′-diyl)bis(N4′-(naphthalen-1-yl)-N4,N4′-diphenylbiphenyl-4,4′-diamine) (Di-NPB), N2,N2′-(9,9-dimethyl-9H-fluorene-2,7-diyl) bis(9,9-dimethyl-N2,N7,N7-triphenyl-9H-fluorene-2,7-diamine) (3DMFL-BPA), N1,N1′-(Biphenyl-4,4′-diyl)bis(N1-(naphthalen-1-yl)-N4,N4-diphenylbenzene-1,4-diamine) (NPB-DPA), N1,N1′-(biphenyl-4,4′-diyl)bis(N1-(naphthalen-2-yl)-N4,N4-diphenylbenzene-1,4-diamine) (β-NPB-DPA), or any mixture or combination thereof.

Suitable phosphorescent host materials include, without limitations, 9,9′,9″-(pyridine-2,4,6-triyltris(benzene-3,1-diyl))tris(9H-carbazole) (TCPY), (4-(9H-carbazol-9-yl)-2,2-dimethyl-[1,1-biphenyl]-4-yl)diphenylphosphine oxide (m-CBPPO), 9,9′-(2-([1,2,4]triazolo[1,5-a]pyridin-2-yl)-1,3-phenylene)bis(9H-carbazole) (o-CzTP), PFN-B, 5-(3-(9-phenyl-9H-carbazol-3-yl)phenyl)-5H-pyrido[3,2-b]indole (DCb-PCz), (5-(9′H-[9,3′:6′,9″-tercarbazol]-9′-yl)pyridin-3-yl)diphenylphosphine oxide (m-POPyCz), 9-(3″-(carbazol-9-yl)-[1,1′,3′,1″-terphenyl]-3-yl)-carbazole-3-carbonitrile (TCzCN), 1392506-99-8 9-(3-(9H-carbazol-9-yl)phenyl)-9H-carbazole-3-carbonitrile (mCPCN), 9-(6-(5H-pyrrolo[2,3-b:4,5-b]dipyridin-5-yl)pyridin-2-yl)-9′-phenyl-9H,9′H-3,3′-bicarbazole (NCzmPy2Cz), 2,7-bis(diphenylphosphoryl)-9-phenyl-9H-carbazole (PPO27), bis-4-(N-carbazolyl)phenyl)phenylphosphine oxide (BCPO), 2,7-bis(diphenylphosphoryl)-9,9′-spirobifluorene (SPPO13), 10-(4′-(diphenylamino)biphenyl-4-yl)acridin9(10H)-one (ADBP), 3-(diphenylphosphoryl)-9-(4-(diphenylphosphoryl)phenyl)-9H-carbazole (PPO21), bis(2-methylphenyl)diphenylsilane (UGH-1), 4,4′-bis(carbazol-9-yl)-2,2′-dimethylbiphenyl (CDBP), 1,3,5-tris(carbazol-9-yl)benzene (TCP), 9,9′-(2-(1-phenyl-1H-benzo[d]imidazol-2-yl)-1,3-phenylene)bis(9H-carbazole) (o-DiCbzBz), 3,3′-(9H,9′H-3,4′-bicarbazole-9,9′-diyl)dibenzonitrile (3CN34BCz), 3,5-di(carbazol-9-yl)-1-phenylsulfonylbenzene (mCPSOB), 3-[3-(9H-carbazol-9-yl)phenyl]furo[2,3-b:5,4-b′]dipyridine 3CzPFP( ) 1,3,5-tris(carbazol-9-yl)benzene (TCP), 4,4′-bis(carbazol-9-yl)-2,2′-dimethylbiphenyl (CDBP), 2,7-bis(carbazol-9-yl)-9,9-dimethylfluorene (DMFL-CBP), 2,2′,7,7′-tetrakis(carbazol-9-yl)-9,9-spirobifluorene (Spiro-CBP), 2,7-bis(carbazol-9-yl)-9,9-ditolylfluorene (DPFL-CBP), 9,9-bis[4-(carbazol-9-yl)-phenyl]fluorene (FL-2CBP), 2,7-bis(carbazol-9-yl)-9,9-spirobifluorene (Spiro-2CBP), 1,4-bis(triphenylsilyl)benzene (UGH-2), 1,3 -bis(triphenylsilyl)benzene (UGH-3), bis(4-N,N-diethylamino-2-methylphenyl)-4-methylphenylmethane (MPMP), 2,7-bis(carbazol-9-yl)-9,9-dioctylfluorene (DOFL-CBP), 4,4″-di(triphenylsilyl)-p-terphenyl (BST), 4,4′-di(triphenylsilyl)-biphenyl (BSB) 9-(4-tert-butylphenyl)-3,6-ditrityl-9H-carbazole (CzC), 9,9-dimethyl-N,N-diphenyl-7-(4-(1-phenyl-1H-benzo[d]imidazol-2-yl)phenyl)-9H-fluoren-2-amine (EFIN), 9,9′-(5-(triphenylsilyl)-1,3-phenylene)bis(9H-carbazole) (SimCP), 4,4,8,8,-12,12-hexa-p-tolyl-4H-8H-12H-12C-azadibenzo[cd,mn]pyrene (FATPA), bis(2-methylphenyl)diphenylsilane (UGH-1), 3,6-bis(carbazol-9-yl)-9-(2-ethyl-hexyl)-9H-carbazole (TCzl), 3-(diphenylphosphoryl)-9-(4-(diphenylphosphoryl)phenyl)-9H-carbazole (PPO21), 3,6-bis[(3,5-diphenyl)phenyl]-9-phenyl-carbazole (CzTP), 10-(4′-(diphenylamino)biphenyl-4-yl)acridin-9(10H)-one (ADBP), 2,7-bis(diphenylphosphoryl)-9,9′-spirobifluorene (SPPO13), 1,4-bis((9H-carbazol-9-yl)methyl)benzene (DCB), bis-4-(N-carbazolyl)phenyl)phenylphosphine oxide (BCPO), 2,7-bis(diphenylphosphoryl)-9-(4-diphenylamino)phenyl-9′-phenyl-fluorene (POAPF), 2,7-bis(diphenylphosphoryl)-9-phenyl-9H-carbazole (PPO27), 2,7-bis(diphenylphosphoryl)spiro[fluorene-7,11′-benzofluorene] (SPPO21), Di(9,9-spirobifluoren-2-yl)-phenyl-phosphine oxide Dspiro-PO( ), 4″,4″-(phenylphosphoryl)bis(N-1-naphthyl-N-phenyl-1,1′:4′,1″-terphenyl-4-amine) NP3PPO( ), 4′″,4″″-(phenylphosphoryl)bis(N-1-naphthyl-N-phenyl-1,1′:4′,1″:4″,1′″-quaterphenyl-4-amine) (NP4PPO), 9-(3,5-bis(diphenylphosphoryl)phenyl)-9H-carbazole (CzPO2)6-(3′,6′-di-tert-butyl-6-(3,6-di-tert-butyl-9H-carbazol-9-yl)-9H-3,9′-bicarbazol-9-yl)-9-(4-(3′,6′-di-tert-butyl-6-(3,6-di-tert-butyl-9H-carbazol-9-yl)-9H-3,9′-bicarbazol-9-yl)phenyl)-3′,6′-bis(3,6-di-tert-butyl-9H-carbazol-9-yl)-9H-3,9′-bicarbamate (G3-tCbz), 3,5-di(9H-carbazol-9-yl)biphenyl (Ph-MCP), 9-phenyl-3,6-bis(4-(1-phenyl-1H-benzo[d]imidazol-2-yl)phenyl)-9H-carbazole (CNBzIm), 9-(3-(9H-carbazol-9-yl)phenyl)-3-(diphenylphosphoryl)-9H-carbazole (mCPPO1), 9,9-Spirobifluoren-4-yl-diphenyl-phosphineoxide SPPO11( ), 9-(8-(diphenylphosphoryl)dibenzo[b,d]furan-2-yl)-9H-carbazole (DFCzPO), dibenzofuran-4-yl-diphenyl-phosphine-oxide (DBFPPO), 3-(3-(9H-carbazol-9-yl)phenyl)benzofuro[2,3-b]pyridine (PCz-BFP), 3-(3-(9H-Carbazol-9-yl)phenyl)benzo[4,5]thieno[2,3-b ]pyridine (BTP1), poly[9-sec-butyl-2,7-difluoro-9H-carbazole] (2,7-F-PVF), 3,3′-di(9H-carbazol-9-yl) biphenyl(m-CBP), 9-(4-(9H-pyrido[2,3-b]indol-9-yl)phenyl)-9H-3,9′-bicarbazole (pBCb2Cz), 3-(4-(9H-carbazol-9-yl)phenyl)-9-(4,6-diphenyl-1,3,5-triazin-2-yl)-9H-carbazole (CPCBPTz), 4,6-bis(3-(9H-carbazol-9-yl)phenyl)pyrimidine (46DCzPPM), 3′-(dibenzo[b,d]thiophen-4-yl)-10-phenyl-10H-spiro[acridine-9,9′-fluorene] (STDBT-4), 9-(3,5-di(triphenylen-2-yl)phenyl)-9H-carbazole (DTP-mCP), 9,9′-diphenyl-9H,9′H-3,3′-bicarbazole (BCzPh), 9,9′-(oxybis([1,1′-biphenyl]-4′,3-diyl))bis(9H-carbazole) (CBBPE), 9,9′-diphenyl-9H,9′H-3,3′-bicarbazole-6-carbonitrile (BCzSCN), 9-(3-(3,5-di(pyridin-2-yl)-1H-1,2,4-triazol-1-yl)phenyl)-9H-carbazole (m-cbtz), 4-(4,6-bis[12-phenylindolo[2,3-a]carbazol-11(12H)-yl]-1,3,5-triazin-2-yl)-benzonitrile (BBICT), 2′-(diphenylphosphinyl)-N,N-bis(4-methylphenyl)-1,1′-Biphenyl]-2-amine (POBPmDPA), 3,3′,3″-phosphinylidynetris[9-phenyl-9H-carbazole (POCz3), 2′-(diphenylphosphoryl)-10-phenyl-10H-spiro[acridine-9,9′-fluorene] (POSTF), 10-phenyl-2′-(triphenylsilyl)-10H-spiro[acridine-9,9′-fluorene] (SSTF), Indolo[3,2-a]carbazole, 5,12-dihydro-6,7-dimethyl-5,12-di-4-pyridinyl (4ICDPy), 1,3-bis(3-(diphenylphosphoryl)phenyl)benzene (BPOPB), 9-(4-(4-phenylquinolin-2-yl)phenyl)-9H-carbazole (CzPPQ), 9-phenyl-9′-(triphenylsilyl)-9H,9′H-3,3′-bicarbazole (BCz-Si), (5-terphenyl-1,3-phenylene)bis(diphenylphosphine oxide) (POPH), 2,2′-di(9H-carbazol-9-yl)biphenyl (o-CBP), or any mixture or combination thereof.

Exemplary fluorescent host materials include, without limitation, 9-(10-phenylanthracen-9-yl)spiro-[benzo[c]fluorene-7,9′-fluorene] (BH-9PA), 9-(naphthalen-1-yl)-10-(naphthalen-2-yl)anthracene, 1,4-bis(9-phenyl-9H-fluoren-9-yl)benzene (pDPFB), synthesis of 3-(9,9′-spirofluorenyl-4-yl)-9,9′-spirofluorene (SF34), 2-methyl-9,10-di(naphthalen-1-yl)anthracene (MAD-1N), 2,7-bis(9,9-spirobifluoren-2-yl)-9,9-spirobifluorene (TSBF), 2-methyl-9,10-bis(naphthalen-2-yl)anthracene (MADN), 2-tert-butyl-9,10-di(naphth-2-yl)anthracene (TBADN), 9,10-di(naphth-2-yl)anthracene (ADN), tris(8-hydroxy-quinolinato)aluminium (Alq3), tris(8-hydroxy-quinolinato)aluminium (Alq3), 9,10-di(naphth-2-yl)anthracene (ADN), 2-tert-butyl-9,10-di(naphth-2-yl)anthracene (TBADN), 4,4′-bis(2,2-diphenylethenyl)-1,1′-biphenyl (DPVBi), 4,4′-bis(2,2-dip-tolylvinyl)biphenyl Chemical (p-DMDPVBi), 2-methyl-9,10-bis(naphthalen-2-yl)anthracene (MADN), 2-(9,9-spirobifluoren-2-yl)-9,9-spirobifluorene (BSBF), 2,7-bis(9,9-spirobifluoren-2-yl)-9,9-spirobifluorene (TSBF), 2-[9,9-di(4-methylphenyl)-fluoren-2-yl]-9,9-di(4-methylphenyl)fluorene ( ), 2,2′-spiro-pye 2,2′-Dipyrenyl-9,9-spirobifluorene, 1,3,5-tri(pyren-1-yl)benzene (TPB3), 9,9-bis[4-(pyrenyl)phenyl]-9H-fluorene (BPPF), 2,2′-bi(9,10-diphenyl-anthracene) (TPBA), 2,7-dipyrenyl-9,9-spirobifluorene (Spiro-Pye), 1,4-di(pyren-1-yl)benzene (p-Bpye), 1,3-di(pyren-1-yl)benzene (m-Bpye), 6,13-di-biphenyl-4-yl-pentacene (DBPenta), 3,9-di(naphthalen-2-yl)perylene and 3,10-di(naphthalen-2-yl) perylene mixture (DNP), 1,1′-(2,5-dimethyl-1,4-phenylene)dipyrene (DMPPP), tris[4-(pyrenyl)-phenyl]amine (TPyPA), 10,10′-di(biphenyl-4-yl)-9,9′-bianthracene (BANE), N,N′-di-(1-naphthalenyl)-N,N′-diphenyl-[1,1′:4′,1″:4″,1′″-quaterphenyl]-4,4′″-diamine (4P-NPB), 4,4′-di[10-(naphthalen-1-yl)anthracen-9-yl]biphenyl (BUBH-3), 1-(7-(9,9′-bianthracen-10-yl)-9,9-dimethyl-9H-fluoren-2-yl)pyrene (BAnFPye), 1-(7-(9,9′-bianthracen-10-yl)-9,9-dihexyl-9H-fluoren-2-yl) (DAnF6Pye), 1-(7-(9,9′-bianthracen-10-yl)-9,9-dioctyl-9H-fluoren-2-yl)pyrene (BAnF8Pye), 9,10-diphenylanthracene (ADP), 1,4-di(spiro[benzo[c]fluorine-7,9′-fluorene]-5-yl)benzene (SBFF2B), tris(6-fluoro-8-hydroxy-quinolinato)aluminium (6FAlq3), bis(8-hydroxyquino line)zinc (Znq2), 9-(5-(3-(9H-carbazol-9-yl)phenyl)pyridin-3-yl)-9H-carbazole (CPPyC), bis(9,9-spirobifluorene-3-yl)-phenylphosphane oxide (SF3PO), or any mixture and combination thereof.

Exemplary green dopant materials include, without limitation, 5,10-bis(4-(3,6-di-tert-butyl-9H-carbazol-9-yl)-2,6-dimethylphenyl)-5,10-dihydroboranthrene (tBuCzDBA), bis(2-(3,5-dimethylphenyl)-4-propylpyridine)(2,2,6,6-tetramethylheptane-3,5-diketonate)iridium(III) (Ir(dmppy-pro)2tmd), 5,10-bis(4-(9H-carbazol-9-yl)-2,6-dimethylphenyl)-5,10-dihydroboranthrene (CzDBA), N10,N10′-bis(4-isopropylphenyl)-N10,N10′-dip-tolyl-9,9′-bianthracene-10,10′-diamine (BPTA AP), N,N′-dimethyl-quinacridone (DMQA), 2,3,6,7-tetrahydro-1,1,7,7,-tetramethyl-1H,5H,11H-10-(2-benzothiazolyl)quinolizino[9,9a,1gh]coumarin (C545T), 3-(2-benzothiazolyl)-7-(diethylamino)coumarin (Coumarin 6), 4,4″-di-10H-phenoxazin-10-yl[1,1′:2′,1″-terphenyl]-4′,5′-dicarbonitrile (Px-VPN), 9,9′,9″-(5-(4,6-diphenyl-1,3,5-triazin-2-yl)benzene-1,2,3-triyptris(3,6-dimethyl-9H-carbazole) (TmCzTrz), 3-(2-benzothiazolyl)-7-(diethylamino)coumarin (Coumarin 6), 2,3,6,7-tetrahydro-1,1,7,7-tetramethyl-1H,5H,11H-10-(2-benzothiazolyl)quinolizino[9,9a,1gh] coumarin (C545T), N,N′-dimethyl-quinacridone (DMQA), bis[2-(2-hydroxyphenyl)benzothiazolato]zinc(II) (Zn(BTZ)2), N10,N10,N10′,N10′-Tetra-tolyl-9,9′-bianthracene-10,10′-diamine (BA-TTB), N10,N10,N10′,N10′--Tetraphenyl-9,9′-bianthracene-10,10′-diamine (BA-TAD), N10,N10′-diphenyl-N10,N10′-dinaphthalenyl-9,9′-bianthracene-10,10′-diamine (BA-NPB), 2,5-bis(4-(10H-phenoxazin-10-yl)phenyl)-1,3,4-oxadiazole (2PXZ-OXD), bis(2-(naphthalen-2-yl)pyridine)(acetylacetonate)iridium(III) (Ir(npy)2acac), tris(2-phenyl-3-methyl-pyridine)iridium (Ir(3mppy)3), OP-09, or any mixture or combination thereof.

Exemplary blue dopant materials include, without limitation, (E)-N,N-diphenyl-4-(4-(pyren-1-yl)styryl)aniline (DPASP), 4,4′-Bis[4-(diphenylamino)styryl]biphenyl (BDAVBi), 4,4′-Bis[4-(di-p-tolylamino)styryl]biphenyl (DPAVBi), 2,5,8,11-Tetra-tert-butylperylene (TBPe), Perylene, 4,4′-Bis(9-ethyl-3-carbazovinylene)-1,1′-biphenyl (BCzVBi), 4,4′-Bis(9-ethyl-3-carbazovinylene)-1,1′-biphenyl (BCzVBi), 2,5,8,11-Tetra-tert-butylperylene (TBPe), 1,4-Bis[2-(3-N-ethylcarbazoryl)vinyl]benzene (BCzVB), 4,4′-Bis[4-(di-p-tolylamino)styryl]biphenyl (DPAVBi), 4-(Di-p-tolylamino)-4′-[(di-p-tolylamino)styryl]stilbene (DPAVB), 4,4′-Bis[4-(diphenylamino)styryl]biphenyl (BDAVBi), 2,7-Bis[4-(diphenylamino)styryl]-9,9-spirobifluorene (Spiro-BDAVBi), N,N′-Bis(naphthalen-2-yl)-N,N′-bis(phenyl)-tris-(9,9-dimethylfluorenylene) (BNP3FL), 2,7-Bis{2-[phenyl(m-tolyl)amino]-9,9-dimethyl-fluorene-7-yl}-9,9-dimethyl-fluorene (MDP3FL), N-(4-((E)-2-(6-((E)-4-(Diphenylamino)styryl)naphthalen-2-yl)vinyl)phenyl)-N-phenylbenzenamine (N-BDAVBi), fac-Iridium(III) tris(1-phenyl-3-methylbenzimidazolin-2-ylidene-C,C2′) (fac-Ir(Pmb)3), mer-Iridium(III) tris(1-phenyl-3-methylbenzimidazolin-2-ylidene-C,C2′) (mer-Ir(Pmb)3), 1-4-Di-[4-(N,N-diphenyl)amino]styryl-benzene (DSA-Ph), 1,4-Bis(4-(9H-carbazol-9-yl)styryl)benzene (BCzSB), Bis(2-(2-hydroxyphenyl)-pyridine)beryllium (Bepp2), Bis(2,4-difluorophenylpyridinato)(5-(pyridin-2-yl)-1H-tetrazolate) iridium(III) (FIrN4), (Z)-6-Mesityl-N-(6-mesitylquinolin-2(1H)-ylidene)quinolin-2-amine-BF2 complex (MQAB), fac-Tris[(2,6-diisopropylphenyl)-2-phenyl-1H-imidazo[e]]iridium(III) (fac-Ir(iprpmi)3), 9-[4-(2-(7-(N,N-Diphenylamino)-9,9-diethylflouren-2-yl)vinyl)phenyl]-9-phenyl-fluorene (DPAFVF), mer-Tris(1-phenyl-3-methylimidazolin-2-ylidene-C,C(2)′iridium(III) (mer-Ir(pmi)3), fac-Tris(1,3-diphenyl-benzimidazolin-2-ylidene-C,C2′)iridium(III) (fac-Ir(dpbic)3), 9-(9-Phenylcarbazole-3-yl)-10-(naphthalene-1-yl)anthracene (PCAN), 4,4′-(1E,1′E)-2,2′-(Naphthalene-2,6-diyl)bis(ethene-2,1-diyl)bis(N,N-bis(4-hexylphenyl)aniline) (N-BDAVBi-C6), Bis(3,5-difluoro-4-cyano-2-(2-pyridyl)phenyl-(2-carboxypyridyl) iridium(III) (FCNIrPic), Bis[4-tert-butyl-2′,6′-difluoro-2,3′-bipyridine](acetylacetonate)iridium(III) (FK306), 4,4′-Bis(4-(9H-carbazol-9-yl)styryl)biphenyl (BSB4), N5,N5,N9,N9-tetraphenylspiro[benzo[c]fluorene-7,9′-fluorene]-5,9-diamine (TPA-SBFF), 10,10′-Bis(3,5-bis(trifluoromethyl)phenyl)-9,9′-bianthracene (Ban-(3,5)-CF3), Bis(3,4,5-trifluoro-2-(2-pyridyl)phenyl-(2-carboxypyridyl)iridium(III) (Ir(tfpd)2pic), N5,N9-Diphenyl-N5,N9-di-m-tolylspiro[benzo[c]fluorene-7,9′-fluorene]-5,9-diamine (BD-6MDPA), 6-Methyl-2-(4-(9-(4-(6-methylbenzo[d]thiazol-2-yl)phenyl)anthracen-10-yl)phenyl)benzo[d]thiazole (DBzA), 10-Phenyl-10H,10′H-spiro[acridine-9,9′-anthracen]-10′-one (ACRSA), Tris(2-(4,6-difuorophenyl)pyridine)iridium(III) (Ir(Fppy)3), 3,6-Dibenzoyl-4,5-Di(1-methyl-9-phenyl-9H-carbazoyl)-2-ethynylbenzonitrile (Cz-VPN), or any mixture and combination thereof.

Exemplary red dopant materials include, without limitation, 5,6-bis(4-(9,9-dimethylacridin-10(9H)-yl)phenyl)pyrazine-2,3-dicarbonitrile (Ac-CNP), Bis(2-(3,5-dimethylphenyl)-4-phenylpyridine)(2,2,6,6-tetramethylheptane-3,5-diketonate)iridium(III) (Ir(dmppy-ph)2tmd), 4-(Dicyanomethylene)-2-tert-butyl-6-(1,1,7,7-tetramethyljulolidin-4-yl-vinyl)-4H-pyran (DCJTB), (E)-2-(2-(4-(Dimethylamino)styryl)-6-methyl-4H-pyran-4-ylidene)malononitrile (DCM), 4-(Dicyanomethylene)-2-methyl-6-julolidyl-9-enyl-4H-pyran (DCM2), 4-(Dicyanomethylene)-2-methyl-6-(1,1,7,7-tetramethyljulolidyl-9-enyl)-4H-pyran (DCJT), 4-(Dicyanomethylene)-2-tert-butyl-6-(1,1,7,7-tetramethyljulolidin-4-yl-vinyl)-4H-pyran (DCJTB), Tris(dibenzoylmethane) phenanthroline europium(III) Eu(dbm)3(Phen)( ), Bis(2-benzo[b]thiophen-2-yl-pyridine) (acetylacetonate)iridium(III) (Ir(btp)2(acac)), bis[1-(9,9-dimethyl-9H-fluoren-2-yl)-isoquinoline](acetylacetonate)iridium(III) (Ir(fliq)2(acac)), bis[2-(9,9-dimethyl-9H-fluoren-2-yl)quinoline](acetylacetonate)iridium(III) (Ir(flq)2(acac)), Tris[4,4′-di-tert-butyl-(2,2′)-bipyridine]ruthenium(III) complex (Ru(dtb-bpy) 32(PF6)), 2,8-di-tert-butyl-5,11-bis(4-tert-butylphenyl)-6,12-diphenyltetracene (TBRb), bis(2-phenylbenzothiazolato)(acetylacetonate)iridium(III) (Ir(BT)2(acac)), platium(II) 5,10,15,20-tetraphenyltetrabenzoporphyrin (Pt(TPBP)), bis[2-(4-n-hexylphenyl)quinoline](acetylacetonate)iridium(III) (Hex-Ir(phq)2(acac)), tris[2-phenyl-4-methylquinoline)]iridium(III) (Ir(Mphq)3), bis(2-phenylquinoline)(2-(3-methylphenyl)pyridinate)iridium(III) (Ir(phq)2tpy), bis(2-phenylpyridine)(3-(pyridin-2-yl)-2H-chromen-2-onate)iridium(III) (fac-Ir(ppy)2Pc), bis(2-phenylquinoline)(2,2,6,6-tetramethylheptane-3,5-dionate)iridium(III) (Ir(dpm)PQ2), bis(phenylisoquinoline)(2,2,6,6-tetramethylheptane-3,5-dionate) iridium(III) (Ir(dpm)(piq)2), (E)-2-(2-tert-butyl-6-(2-(2,6,6-trimethyl-2,4,5,6-tetrahydro-1H-pyrrolo[3,2,1-ij]quinolin-8-yl)vinyl)-4H-pyran-4-ylidene)malononitrile (DCQTB), bis[(4-n-hexylphenyl)isoquinoline](acetylacetonate)iridium (III) (Hex-Ir(piq)2(acac)), bis(2-methyldibenzo[f,h]quinoxaline) (acetylacetonate)iridium(III) (Ir(MDQ)2(acac)), tris(2-(3-methylphenyl)-7-methyl-quinolato)iridium (Ir(dmpq)3), Bis[2-(2-methylphenyl)-7-methyl-quinoline](acetylacetonate)iridium(III) (Ir(dmpq)2acac), Iridium(III)bis(2-(2,4-difluorophenyl)quinoline)picolinate (FPQIrpic), Bis[2-(9-phenylcarbazol-2-yl)-benzothiazole]iridium(III)picolinate (Ir(2-BtcPh)2(pic)), Tris[3-(2,6-dimethylphenoxy)-6-phenylpyridazine]iridium(III) (Ir(DMP)3), Bis[2-(3,5-dimethylphenyl)-4-methyl-quinoline](acetylacetonate)iridium(III) (Ir(mphmq)2acac), PO-01, PO-08. (E)-2-(2-(4-(Dimethylamino)styryl)-1-ethylquinolin-4(1H)-ylidene)malononitrile (ED), 3,6-Dibenzoyl-4,5-Di(1-methyl-9-phenyl-9H-carbazoyl)-2-ethynylbenzonitrile (Ir(ppy)3-Bp), or any mixture and combination thereof.

Exemplary electron transport/hole blocking layer materials include, without limitation, PFN-B-diiodine salt, PFN-diiodine salt, 2,4,6-Tris(3-(pyrimidin-5-yl)phenyl)-1,3,5-triazine (TPM-TAZ), 8-Hydroxyquinolinolato-lithium (1), 1,3,5-Tris(1-phenyl-1Hbenzimidazol-2-yl)benzene (TPBi), Bis(2-methyl-8-quinolinolate)-4-(phenylphenolato)aluminium (BAlq), 1,3-Bis[2-(2,2′-bipyridine-6-yl)-1,3,4-oxadiazo-5-yl]benzene (Bpy-OXD), 6,6′-Bis[5-(biphenyl-4-yl)-1,3,4-oxadiazo-2-yl]-2,2′-bipyridyl (BP-OXD-Bpy), 4-(Naphthalen-1-yl)-3,5-diphenyl-4H-1,2,4-triazole (NTAZ), 2,9-Bis(naphthalen-2-yl)-4,7-diphenyl-1,10-phenanthroline (NBphen), 2,7-Bis[2-(2,2′-bipyridine-6-yl)-1,3,4-oxadiazo-5-yl]-9,9-dimethylfluorene (Bpy-FOXD), 1-Methyl-2-(4-(naphthalen-2-yl)phenyl)-1H-imidazo[4,5f][1,10]phenanthroline (2-NPIP), 2-(Naphthalen-2-yl)-4,7-diphenyl-1,10-phenanthroline (HNBphen), Phenyl-dipyrenylphosphine oxide (POPy2), 4,4′-Bis(4,6-diphenyl-1,3,5-triazin-2-yl)biphenyl (BTB), 1,3-Bis[3,5-di(pyridin-3-yl)phenyl]benzene (BmPyPhB), 2-(4-(9,10-Di(naphthalen-2-yl)anthracen-2-yl)phenyl)-1-phenyl-1H-phenanthro[9,10-d]imidazole (Bepq2), Diphenylbis(4-(pyridin-3-yl)phenyl)silane (DPPS), 3,5-Di(pyren-1-yl)pyridine (PY1), 1,3,5-Tri(p-pyrid-3-yl-phenyl)benzene (TpPyPB), 2,4,6-Tris(3′-(pyridin-3-yl)biphenyl-3-yl)-1,3,5-triazine (TmPPPyTz), 4,6-Bis(3,5-di(pyridin-3-yl)phenyl)-2-methylpyrimidine (B3PYMPM), 1,3,5-Tris(4-(pyridin-4-yl)quinolin-2-yl)benzene (TPyQB), 4,6-Bis(3,5-di(pyridin-4-yl)phenyl)-2-methylpyrimidine (B4PYMPM), 1394813-58-1 2,7-Di(2,2′-bipyridin-5-yl)triphenylene (BPy-TP2), 2,2′-(4,4′-(Phenylphosphoryl)bis(4,1-phenylene))bis(1-phenyl-1H-benzo[d]imidazole) (BIPO), Lithium 2-(2′,2″-bipyridine-6′-yl)phenolate (Libpp), 4,6-Bis(3,5-di(pyridin-4-yl)phenyl)-2-phenylpyrimidine (B4PYPPM), 1,3,5 -Tris(6-(3-(pyridin-3-yl)phenyl)pyridin-2-yl)benzene (Tm3PyP26PyB), 4,6-Bis(3,5-di(pyridin-3-yl)phenyl)-2-(pyridin-3-yl)pyrimidine (B3PYPPM), 4,6-Bis(3,5-di(pyridin-4-yl)phenyl)-2-(3-(pyridin-3-yl)phenyppyrimidine (B4PYPPyPM), 1,3,5-Tri(diphenylphosphoryl-phen-3-yl) benzene (TP3PO), Poly[9,9-bis[6′-(N,N,N-trimethylammonium)hexyl]fluorene-alt-co-1,4-phenylene]bromide (FPQ-Br), 8-Hydroxyquinoline sodium salt (NaQ), 4,7-Diphenyl-2,9-bis(4-(1-phenyl-1H-benzo[d]imidazol-2-yl)phenyl)-1,10-phenanthroline (DBimiBphen), 2,4,6-Tris[3-(diphenylphosphinyl)phenyl]-1,3,5-triazine (PO-T2T), or any mixture and combination thereof.

Exemplary electron injection layer (EIL) materials and metals include, without limitation, Rubidium carbonate, Rhenium(VI) oxide, or any mixture and combination thereof.

### EMBODIMENTS OF THE DISCLOSURE

Embodiment 1. An apparatus comprising:
one or more power generating elements; and
one or more light emitting elements,
wherein the power generating elements provide electric power to the one or more light emitting elements.

Embodiment 2. The apparatus of Embodiment 1, further comprising:
one or more processing units,
wherein the power generating members supplies or is configured to supply power to the other components.

Embodiment 3. The apparatus of Embodiment 1 or 2, further comprising:
one or more sensors,
wherein the power generating members supplies or is configured to supply power to the other components.

Embodiment 4. The apparatus of Embodiment 1, 2, or 3, wherein the one or more processing units are configured to receive information from the sensors and to control the light emitting members based on the information received from the sensors and varying the light output from the light emitting members over time according to pre-programmed routines, randomly varying the output based on sensor input data, or by any other software routine for varying the output over time based on sensor input data.

Embodiment 5. The apparatus of Embodiment 1, 2, 3, or 4, wherein the sensors comprise thermal sensors, light sensors, sound sensors, motion sensors, or any combination thereof.

Embodiment 6. The apparatus of Embodiment 1, 2, 3, 4, or 5, further comprising:
one or more hydrogels or hypoallergenic polymeric materials embed or surround or encase the power generating elements, the one or more the light emitting elements, the one or more processing units, the one or more sensors, or any combination thereof.

Embodiment 7. The apparatus of Embodiment 1, 2, 3, 4, 5, or 6, wherein the power generating elements comprise body heat or thermal power generating elements.

Embodiment 8. The apparatus of Embodiment 1, 2, 3, 4, 5, 6, or 7, wherein the power generating elements comprise neuron or brain wave power generating elements.

Embodiment 9. The apparatus of Embodiment 1, 2, 3, 4, 5, 6, 7, or 8, wherein the power generating elements comprise a plurality of multi-layered power generating constructs including conductor layers, insulator layers, and p/n semiconductor layers that convert body heat into electrical energy.

Embodiment 10. The apparatus of Embodiment 1, 2, 3, 4, 5, 6, 7, 8, or 9, wherein the power generating elements further comprise two power leads for connecting the power generating elements to one other and to one or more light emitting elements.

Embodiment 11. An apparatus comprising:
one or more power generating elements including one or more antenna or coils; and
one or more light emitting elements,
wherein the power generating elements provide electric power to the one or more light emitting elements. the power generating elements may be coils.

Embodiment 12. The apparatus of Embodiment 11, wherein one or more antenna or coils absorb electric energy from a cell phone or a cell signal.

Embodiment 13. The apparatus of Embodiment 11 or 12, wherein one or more antenna or coils absorb electric energy from a portable electric field generator.

Embodiment 14. The apparatus of Embodiment 11, 12, or 13, further comprising:
one or more processing units,
wherein the power generating members supplies or is configured to supply power to the other components.

Embodiment 15. The apparatus of Embodiment 11, 12, 13, or 14, further comprising:
one or more sensors,
wherein the power generating members supplies or is configured to supply power to the other components.

Embodiment 16. The apparatus of Embodiment 11, 12, 13, 14, or 15, wherein the one or more processing units are configured to receive information from the sensors and to control the light emitting members based on the information received from the sensors and varying the light output from the light emitting members over time according to pre-programmed routines, randomly varying the output based on sensor input data, or by any other software routine for varying the output over time based on sensor input data.

Embodiment 17. The apparatus of Embodiment 11, 12, 13, 14, 15, or 16, wherein the sensors comprise thermal sensors, light sensors, sound sensors, motion sensors, or any combination thereof.

Embodiment 18. The apparatus of Embodiment 11, 12, 13, 14, 15, 16, or 17, further comprising:
one or more hydrogels or hypoallergenic polymeric materials embed or surround or encase the power generating elements, the one or more the light emitting elements, the one or more processing units, the one or more sensors, or any combination thereof.

Embodiment 19. A method comprising:
contacting a piece of jewelry with a body part of an animal, a mammal, or a human, the piece of jewelry including: (a) one or more power generating elements; and (b) one or more light emitting elements so that the one or more power generating elements are in thermal contact with the body part;
converting thermal energy in the body part into electric power via the one or more power generating elements; and
powering the one or more light emitting elements with the electric power converted by the one or more power generating elements to illuminate one or more gem stones associated with the piece of jewelry.

Embodiment 20. A method for making jewelry comprising one or more power generating elements and one or more light emitting elements, where the methods include constructing the power generating elements, affixing the power generating elements to a piece of jewelry, and connecting the leads of the generating elements to the light emitting elements disposed on the jewelry to illuminate one or more gem stones associated with the jewelry.

### CLOSING PARAGRAPH OF THE DISCLOSURE

All references cited herein are incorporated by reference. Although the disclosure has been disclosed with reference to its preferred embodiments, from reading this description those of skill in the art may appreciate changes and modification that may be made which do not depart from the scope and spirit of the disclosure as described above and claimed hereafter.

We claim:

1. An apparatus comprising:
one or more power generating elements; and
one or more light emitting elements,
wherein the power generating elements provide electric power to the one or more light emitting elements.

2. The apparatus of claim 1, further comprising:
one or more processing units,
wherein the power generating members supplies or is configured to supply power to the other components.

3. The apparatus of claim 2, further comprising:
one or more sensors,
wherein the power generating members supplies or is configured to supply power to the other components.

4. The apparatus of claim 3, wherein the one or more processing units are configured to receive information from the sensors and to control the light emitting members based on the information received from the sensors and varying the light output from the light emitting members over time according to pre-programmed routines, randomly varying the output based on sensor input data, or by any other software routine for varying the output over time based on sensor input data.

5. The apparatus of claim 4, wherein the sensors comprise thermal sensors, light sensors, sound sensors, motion sensors, or any combination thereof.

6. The apparatus of claim 5, further comprising:
one or more hydrogels or hypoallergenic polymeric materials embed or surround or encase the power generating elements, the one or more the light emitting elements, the one or more processing units, the one or more sensors, or any combination thereof.

7. The apparatus of claim 1, wherein the power generating elements comprise body heat or thermal power generating elements.

8. The apparatus of claim 1, wherein the power generating elements comprise neuron or brain wave power generating elements.

9. The apparatus of claim 1, wherein the power generating elements comprise a plurality of multi-layered power generating constructs including conductor layers, insulator layers, and p/n semiconductor layers that convert body heat into electrical energy.

10. The apparatus of claim 1, wherein the power generating elements further comprise two power leads for connecting the power generating elements to one other and to one or more light emitting elements.

11. An apparatus comprising:
one or more power generating elements including one or more antenna or coils; and
one or more light emitting elements,
wherein the power generating elements provide electric power to the one or more light emitting elements, the power generating elements may be coils.

12. The apparatus of claim 11, wherein one or more antenna or coils absorb electric energy from a cell phone or a cell signal.

13. The apparatus of claim 11, wherein one or more antenna or coils absorb electric energy from a portable electric field generator.

14. The apparatus of claim 11, further comprising:
one or more processing units,
wherein the power generating members supplies or is configured to supply power to the other components.

15. The apparatus of claim 14, further comprising:
one or more sensors,
wherein the power generating members supplies or is configured to supply power to the other components.

16. The apparatus of claim 15, wherein the one or more processing units are configured to receive information from the sensors and to control the light emitting members based on the information received from the sensors and varying the light output from the light emitting members over time according to pre-programmed routines, randomly varying the output based on sensor input data, or by any other software routine for varying the output over time based on sensor input data.

17. The apparatus of claim 16, wherein the sensors comprise thermal sensors, light sensors, sound sensors, motion sensors, or any combination thereof.

18. The apparatus of claim 17, further comprising:
one or more hydrogels or hypoallergenic polymeric materials embed or surround or encase the power generating elements, the one or more the light emitting elements, the one or more processing units, the one or more sensors, or any combination thereof.

19. A method comprising:
contacting a piece of jewelry with a body part of an animal, a mammal, or a human, the piece of jewelry including: (a) one or more power generating elements; and (b) one or more light emitting elements so that the one or more power generating elements are in thermal contact with the body part;
converting thermal energy in the body part into electric power via the one or more power generating elements; and
powering the one or more light emitting elements with the electric power converted by the one or more power generating elements to illuminate one or more gem stones associated with the piece of jewelry.
